(19) United States
(12) Patent Application Publication
(10) Pub. No.: US 2012/0253061 A1
(43) Pub. Date: Oct. 4, 2012

(54) 3D IMAGE DISPLAY APPARATUS, METHOD OF MANUFACTURING THE SAME, PHASE DIFFERENCE PLATE, 3D IMAGE DISPLAY SYSTEM, AND ADHESIVE COMPOSITION FOR 3D IMAGE DISPLAY APPARATUS

(75) Inventor: Keita TAKAHASHI, Kanagawa (JP)

(73) Assignee: FUJIFILM Corporation, Tokyo (JP)

(21) Appl. No.: 13/435,902

(22) Filed: Mar. 30, 2012

(30) Foreign Application Priority Data
Mar. 31, 2011 (JP) 2011-077782

(51) Int. Cl. C09J 175/14; B32B 37/12; G02F 1/1335; G02B 27/22; G02B 27/26

(52) U.S. Cl. 560/158; 359/464; 359/465; 349/15; 156/60

(57) ABSTRACT

A 3D image display apparatus has an image display panel portion that is driven based on image signals, and a phase difference plate that is disposed on an observation side of the image display panel portion and has at least a patterned optically anisotropic layer, in which the image display panel portion and the phase difference plate are adhered to each other through an adhesive composition having a glass transition temperature of room temperature or lower, and at least one of surfaces adhered through the adhesive composition is a film including a cellulose derivative.

### BACKGROUND OF THE INVENTION

1. Field of the Invention

The present invention relates to a 3D image display apparatus having an optically anisotropic layer with a high-definition pattern, a method of manufacturing the same, a phase difference plate, a 3D image display system, and an adhesive composition for a 3D image display apparatus.

2. Description of the Related Art

In a 3D image display apparatus that displays stereoscopic images, an optical member for making right-eye images and left-eye images into, for example, circularly polarized images in mutually opposite directions is required. For example, as such an optical member, a patterned phase difference plate is used in which areas having mutually different retarded axes, retardation, and the like are regularly disposed in the surface.

The supporting body of the patterned phase difference plate is classified into two kinds of supporting bodies composed of glass and supporting bodies composed of films. The supporting bodies composed of glass have been frequently used due to their advantages in which expansion and shrinkage due to heating and cooling in the manufacturing processes or expansion and shrinkage due to a change in temperature and humidity over time are suppressed compared to the supporting bodies composed of films, however, in recent years, a trend of using a patterned phase difference plate having a supporting body composed of films (hereinafter also referred to as the “FRP”) is spreading from an economic viewpoint.

In order to manufacture a 3D image display apparatus using FRP, it is necessary to adhere the patterned phase difference plate and a polarization plate of a display panel portion or the patterned phase difference plate and a display panel, and high-definition alignment is required. In addition, since FRP is significantly expanded and shrunk compared to a case in which a supporting body is composed of glass, it is also necessary to take the dimensional change of the film into account.

JP4482588B proposes a method of manufacturing a stereoscopic image display apparatus by carrying out a coating process in which a resin is coated on the right-eye image-generating area and the left-eye image-generating area in an image display portion, and an area in which the right-eye polarization area and the left-eye polarization area of a phase difference plate are overlapped, a placing process in which the resin-coated surfaces are aligned to face each other, a deaerating process in which air in the resin is deaerated, a laminating process in which the surfaces are pressed and laminated, and an adhering process in which the resin is cured.

In addition, for example, JP4528333B proposes a method in which recesses and protrusions on the surface due to expansion and shrinkage of the phase difference plate are suppressed by changing the kind of an adhesive that adheres the ejection surface of the image display portion and the incident surface of the phase difference plate and an adhesive that adheres the peripheral portion of the image display portion and the peripheral portion of the phase difference plate.

In addition, JP2011-22419A proposes that array pitches in the phase difference areas and array pitches in the pixel electrodes can be made to be mutually equivalent by using a transparent resin film having a coefficient of humidity expansion of 5×10⁻⁵% RH or more as a supporting body so as to control the humidity of the transparent resin film during adhesion. It is disclosed that a triacetyl cellulose film can be used as the transparent resin film.

### SUMMARY OF THE INVENTION

However, JP4482588B and JP4528333B simply disclose the effects of being flexible to bending and achieving flatness, do not describe an effect of compensating dimensional changes (coefficient of thermal expansion (CTE), coefficient of humidity expansion (CHE)), which is a characteristic problem of films, and also do not disclose the composition and the like of an adhesive which is proposed in consideration of the configuration of FRP.

In addition, in JP2011-22419A, the above problem is solved by using a transparent resin film having, conversely, a large coefficient of humidity expansion (5×10⁻⁵% RH or more), such as a triacetyl cellulose film, but the film having a large coefficient of humidity expansion is liable to absorb water, and a problem is caused in humidity resistance tests.

The invention has been made to solve the above problem, and an object of the invention is to reduce crosstalk in a 3D image display apparatus equipped with a phase difference plate having a patterned optically anisotropic layer with a fine pattern which is caused by location deviation of the phase difference plate.

Specifically, the object is to provide a 3D image display apparatus for which crosstalk is reduced, a method of manufacturing the same, a phase difference plate that is used in the same, a 3D image display system, and an adhesive composition for a 3D image display apparatus.

Measures to solve the above problem are as follows:

[1] A 3D image display apparatus having an image display panel portion that is driven based on image signals, and a phase difference plate that is disposed on an observation side of the image display panel portion and has at least a patterned optically anisotropic layer, in which the image display panel portion and the phase difference plate are adhered to each other through an adhesive composition having a glass transition temperature of room temperature or lower, and at least one of surfaces adhered through the adhesive composition is a film including a cellulose derivative.

[2] The 3D image display apparatus according to [1], in which the adhesive composition is cured by ultraviolet rays.

[3] The 3D image display apparatus according to [1] or [2], in which the adhesive composition contains a polyol compound.

[4] The 3D image display apparatus according to [3], in which the polyol compound is a urethane acrylate.

[5] The 3D image display apparatus according to any one of [1] to [4], in which the viscosity of the adhesive composition before being cured is 0.1 cP to 1000 cP.

[6] The 3D image display apparatus according to any one of [1] to [5], in which the mass average molecular weight of the adhesive composition is 100 to 1×10⁷.

[7] The 3D image display apparatus according to any one of [1] to [6], in which the phase difference plate has a film including a cellulose derivative that supports the patterned optically anisotropic layer, and a surface of the film is adhered to the image display panel portion.

[8] The 3D image display apparatus according to any one of [1] to [6], in which the phase difference plate has a polarizer and a film including a cellulose derivative laminated on a surface of the polarizer, and a surface of the film is adhered to the image display panel portion.

[9] The 3D image display apparatus according to any one of [1] to [8], in which a film including a cellulose derivative is provided on the adhered surface of the image display panel portion.

[10] The 3D image display apparatus according to any one of [1] to [9], in which the cellulose derivative is triacetyl cellulose.

[11] The 3D image display apparatus according to any one of [1] to [10], in which the image display panel portion has a liquid crystal cell.

[12]A 3D image display system having the 3D image display apparatus according to any one of [1] to [11], and glasses for making each of right-eye and left-eye polarized images displayed on the 3D image display apparatus incident on each of the right eye and left eye of an observer.

[13]A method of manufacturing the 3D image display apparatuses according to [1] to [11] including at least aligning the phase difference plate having at least a patterned optically anisotropic layer and the image display panel portion in a state in which the adhesive composition having a glass transition temperature of room temperature or less is interposed, and adhering the phase difference plate and the image display panel portion by curing the adhesive composition after the aligning.

[14]A phase difference plate for a 3D image display apparatus having at least a patterned optically anisotropic layer, in which an adhesive layer including an adhesive composition having a glass transition temperature of room temperature or lower is provided on one surface.

[15] The phase difference plate for a 3D image display apparatus according to [14] having a film including a cellulose derivative, in which the adhesive layer is provided on a surface of the film.

[16] An adhesive composition for a 3D image display apparatus containing a polyol compound, for which the glass transition temperature is room temperature or lower.

According to the invention, it is possible to reduce crosstalk in a 3D image display apparatus equipped with a phase difference plate having a patterned optically anisotropic layer with a fine pattern which is caused by location deviation of the phase difference plate.

Specifically, according to the invention, it is possible to provide a 3D image display apparatus for which crosstalk is reduced, a method of manufacturing the same, a phase difference plate that is used in the same, a 3D image display system, and an adhesive composition for a 3D image display apparatus.

### BRIEF DESCRIPTION OF THE DRAWINGS

FIGS. 1A to 1D are schematic cross-sectional views showing examples of the 3D image display apparatus of the invention.

FIG. 2 is a schematic view of an example of the relationship between a polarization film and an optically anisotropic layer.

FIG. 3 is a schematic view of an example of the relationship between a polarization film and an optically anisotropic layer.

FIG. 4 is a schematic top surface view of an example of the patterned optically anisotropic layer according to the invention.

### DESCRIPTION OF THE PREFERRED EMBODIMENTS

Hereinafter, the invention will be described in detail. Meanwhile, in the present specification, the numerical ranges expressed using “to” refer to ranges that include numeric values specified before and after the “to” as the lower limit value and the upper limit value. Firstly, terminologies that will be used in the specification will be described.

In the specification, Re (λ) and Rth (λ) indicate the retardation in the surface and the retardation in the thickness direction at a wavelength of λ. Re (λ) is measured by making light rays having a wavelength of λ nm be incident in the normal direction to a film in a KOBRA 21ADH or WR (manufactured by Oji Scientific Instruments). The measurement wavelength λ nm can be selected by manually exchanging wavelength-selecting filters, or converting measured values using a program or the like.

In a case in which the measured film is expressed as a uniaxial or biaxial refractive index ellipsoid, the Rth (λ) is computed by the following method.

Re (λ) is measured at a total of six points by making light rays having a wavelength of λ nm be incident from directions inclined at 10 degree intervals from the normal direction to 50 degrees with respect to the normal direction to the film when retarded axes in the surface (determined using a KOBRA 21ADH or WR) are used as inclined axes (rotation axes) (in the case of no retarded axis, arbitrary directions in the film surface are used as the rotation axes), and Rth (λ) is computed using a KOBRA 21ADH or WR based on the measured retardation values, an assumed value of the average refractive index, and the input film thickness value.

In the above, in a case in which a film has a direction at which the retardation value becomes zero at an inclined angle when retarded axes in the surface from the normal direction are used as the rotation axes, the retardation values at inclined angles larger than the above inclined angle are changed to be negative values, and then the KOBRA 21ADH or WR computes Re (λ).

Meanwhile, it is also possible to compute Rth by measuring retardation values from two arbitrary inclined angles when retarded axes are used as the inclined axes (rotation axes) (in the case of no retarded axis, arbitrary directions in the film surface are used as the rotation axes), and using the following formulae (1) and (2) based on the measured values, an assumed value of the average refractive index, and the input film thickness.

$$Re ( θ ) = [ nx - \frac{( ny \times nz )}{( \sqrt{{( ny sin ( {sin}^{- 1} ( \frac{sin ( - θ )}{nx} ) ) )}^{2} + {( nz cos ( {sin}^{- 1} ( \frac{sin ( - θ )}{nx} ) ) )}^{2}} )} ] \times \frac{d}{cos ( {sin}^{- 1} ( \frac{sin ( - θ )}{nx} ) )} \qquad Formula ( 1 )$$

The above Re (θ) represents a retardation value in a direction inclined by θ degrees from the normal direction.

In the formula (1), nx represents the refractive index in the retarded axis direction in the surface, ny represents the refractive index in the orthogonal direction to nx in the surface, and nz represents the refractive index in the orthogonal direction to nx and ny.

Rth={(nx+ny)/2−nz}×d Formula (2):

In the formula (2), nx represents the refractive index in the retarded axis direction in the surface, ny represents the refractive index in the orthogonal direction to nx in the surface, and nz represents the refractive index in the orthogonal direction to nx and ny. d represents the film thickness.

In a case in which a measured film does not have an axis that can be expressed as a uniaxial or biaxial refractive index ellipsoid, which is a so-called optical axis, Rth (λ) is computed by the following method. Re (λ) is measured at 11 points by making light rays having a wavelength of λ nm be incident from directions inclined at 10 degree intervals from −50 degrees to +50 degrees with respect to the normal direction to the film when retarded axes in the surface (determined using a KOBRA 21ADH or WR) are used as inclined axes (rotation axes), and Rth (λ) is computed using the KOBRA 21ADH or WR based on the measured retardation values, an assumed value of the average refractive index, and the input film thickness value.

In the above measurement, values in the Polymer Handbook (JOHN WILEY & SONS, INC) and a variety of optical film catalogs can be used as the assumed value of the average refractive index. For films with no known average refractive index value, the refractive index value can be measured using an Abbe refractometer. The average refractive index values of principal optical films will be as follows: cellulose acylate (1.48), cycloolefin polymer (1.52), polycarbonate (1.59), polymethyl methacrylate (1.49), and polystyrene (1.59). When an assumed value of the average refractive index and a film thickness are input, a KOBRA 21ADH or WR computes nx, ny, and nz, and Nz=(nx−nz)/(nx−ny) is further computed using the computed nx, ny, and nz.

In addition, in the invention, the glass transition temperature (Tg) refers to a glass transition temperature obtained by differential scanning calorimetry (DSC). In addition, room temperature refers to 25° C. or lower.

The 3D image display apparatus of the invention is a 3D image display apparatus having an image display panel portion, and a phase difference plate that is disposed on an observation side of the image display panel portion and has at least a patterned optically anisotropic layer, in which the image display panel portion and the phase difference plate are adhered to each other through an adhesive composition having a glass transition temperature of room temperature or lower, and at least one of surfaces adhered through the adhesive composition is a film including a cellulose derivative.

An adhesive composition having the above characteristics has a movable liquid viscosity (air bubbles are not included) before being cured, and the cure shrinkage is also small when the adhesive composition is cured by an external stimulus. Therefore, aligning is easy during adhesion, and location deviation due to shrinkage after adhesion is not caused, whereby crosstalk can be significantly reduced.

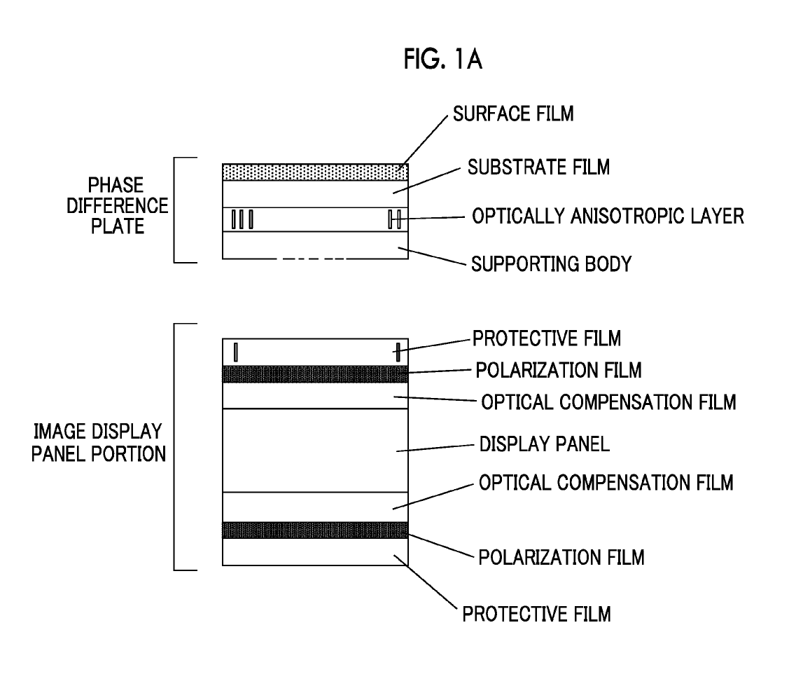

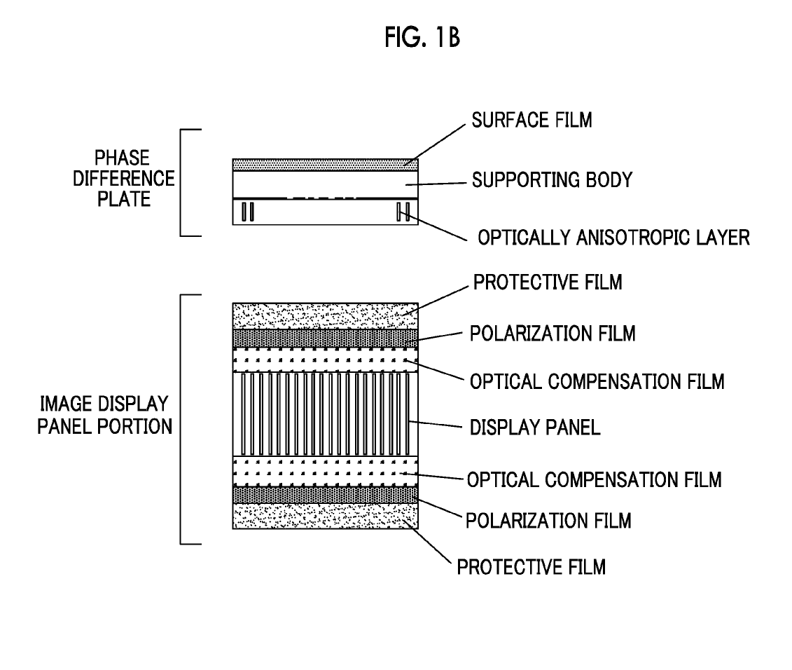

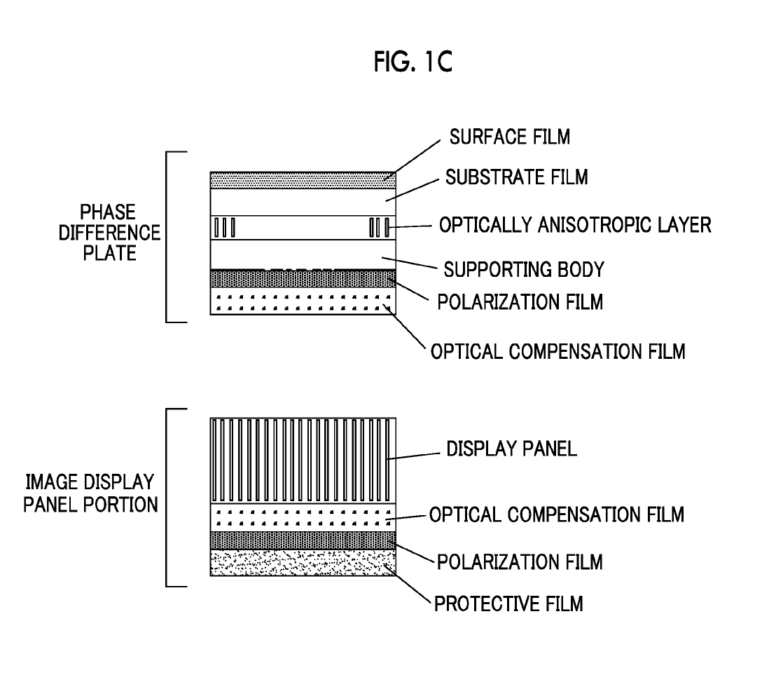

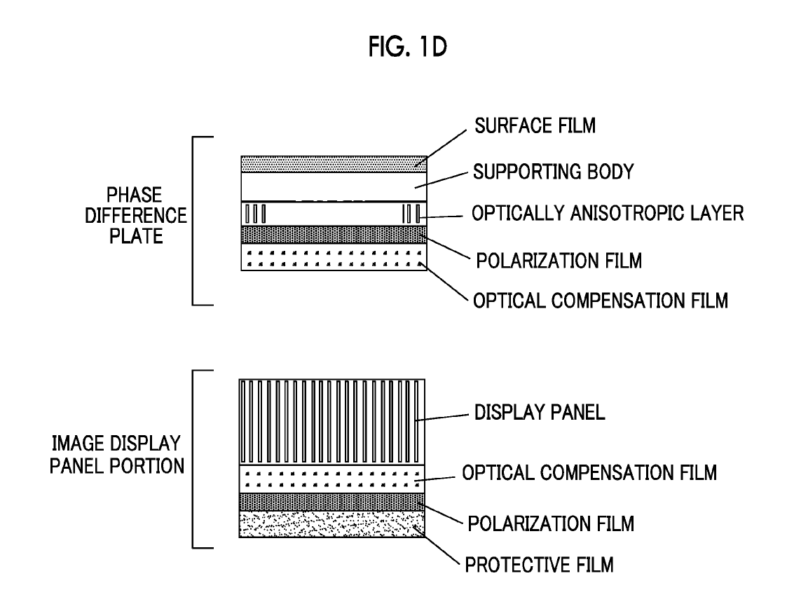

The 3D image display apparatus having a patterned optically anisotropic layer with a fine pattern can be manufactured by adhering a laminated member including the patterned optically anisotropic layer and an image display panel portion as shown in several examples in FIGS. 1A to 1D. However, both the phase difference plate and the image display panel portion include a variety of optical films, such as the protective film for the polarization plate, an optical compensation film, and a transparent supporting body film in the phase difference plate, and therefore the phase difference plate and the image display panel portion are expanded and shrunk so as to be bent as the films are heated and cooled in the manufacturing processes. The glass transition temperature of the adhesive is desirably low after curing of the adhesive in consideration of dimensional changes of the films. In addition, the glass transition temperature of the adhesive is desirably low since the adhesive is flexible enough to follow recesses and protrusions present on the surfaces of the films.

However, the adhesive having a low glass transition temperature has a problem in that the adhesion force cannot be maintained even when the adhesive is cured using an external stimulus, and therefore, in the related art, it was not possible to follow dimensional changes while the adhesion force was maintained. In addition, compared to an ordinary optical member, position alignment operations are complex in the phase difference plate with a fine pattern, and the adhesive for an optical member in the related art could not satisfy the position alignment workability.

As a result of thorough studies by the present inventors, it was found that it is possible to follow dimensional changes while the adhesion force is maintained, and, furthermore, to improve the position alignment workability when adhering the phase difference plate with a fine pattern by using an adhesive having a glass transition temperature of room temperature or lower and using films including a cellulose derivative as films to be adhered, and the invention was completed. The adhesive composition having a glass transition temperature of room temperature or lower has a low viscosity before being cured, the positions of the phase difference plate and the image display panel portion can be easily aligned in a state in which the adhesive composition is interposed, and positional deviation during adhesion can be reduced. Furthermore, since the adhesive having a low glass transition temperature is hydrophilic, the adhesive can maintain high adhesion properties with respect to the cellulose derivative present on the adhesion surface when being cured. Furthermore, water molecules can move into the adhesive from the film including the cellulose derivative present on the adhesion surface, and dimensional changes due to humidity are reduced. Thereby, it is possible to suppress the positional deviation of the phase difference plate even after adhesion.

In addition, since manufacturing of the phase difference plate is difficult and costly, in a case in which positional deviation occurs during adhesion, it is desirable to separate the phase difference plate from the image display panel portion and reuse the phase difference plate. Since the adhesive composition is excellent in terms of the adhesion properties with the surface of a cellulose acylate film when being cured, the phase difference plate can be reused by being separated together with the cellulose acylate film. That is, the invention is also excellent in terms of workability and reworkability of separating and re-adhering the phase difference plate when alignment is failed.

In a preferable aspect of the invention, the adhesive composition contains a polyol compound. In the present aspect, the hydroxyl group included in the cellulose derivative forms a hydrogen bond with the polyol compound included in the adhesive composition, and the adhesion properties are further improved. In addition, the reworkability is also improved, which is preferred.

The adhesive composition used in the invention is available as long as at least one of layers that are adhered through the adhesive composition is a film including a cellulose derivative (sometimes referred to as the “cellulose acylate film.”). The cellulose acylate film may be present on a to-be-adhered surface of the phase difference plate, or a to-be-adhered surface of the image display panel portion. In addition, it is needless to say that the cellulose acylate film may be present on both.

A schematic cross-sectional view of an example of the 3D image display apparatus of the invention is shown in FIG. 1A. Meanwhile, in the drawing, the relative relationship of the thickness between the respective layers is not necessarily coincident with the actual relative relationship of the thickness between the respective layers. In addition, the space between the phase difference plate and the image display panel portion in the drawing is not present in an actual 3D image display apparatus, and simply interposed to indicate the position of the adhesion surfaces to be adhered using the adhesive composition.

The 3D image display apparatus of the invention has the image display panel portion and the phase difference plate. The phase difference plate is disposed on an observation-side of the image display panel portion, and has a function of converting images displayed by the image display panel portion to polarized images, such as right-eye and left-eye circularly polarized images or linearly polarized images. An observer observes the images through the polarization plate, such as circularly polarized or linearly polarized glasses, and recognizes the images as stereoscopic images.

The phase difference plate is disposed at the outside of the display panel on the observation side (in a case in which a polarization film is provided on the observation side of the image display panel, at the outside of the polarization film on the observation side of the image display panel portion) together with the polarization film, and polarized images that have passed through first and second phase difference areas in the phase difference plate respectively are recognized through the polarization glasses or the like as right-eye or left-eye images. Therefore, the first and second phase difference areas preferably have mutually the same shape so as to prevent left and right images from becoming uneven, and the first and second phase difference areas are preferably disposed evenly and symmetrically.

The phase difference plate has the transparent supporting body and the patterned optically anisotropic layer, and the phase difference plate may include other members. In the example as shown in FIG. 1A, the phase difference plate may have an oriented film between the transparent supporting body and the optically anisotropic layer, and may have a surface film including an anti-reflection layer disposed at the outside of the optically anisotropic layer.

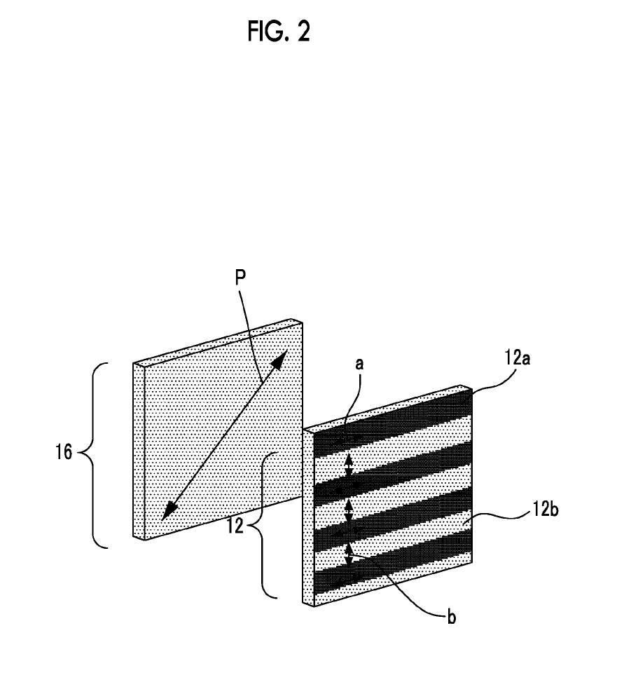

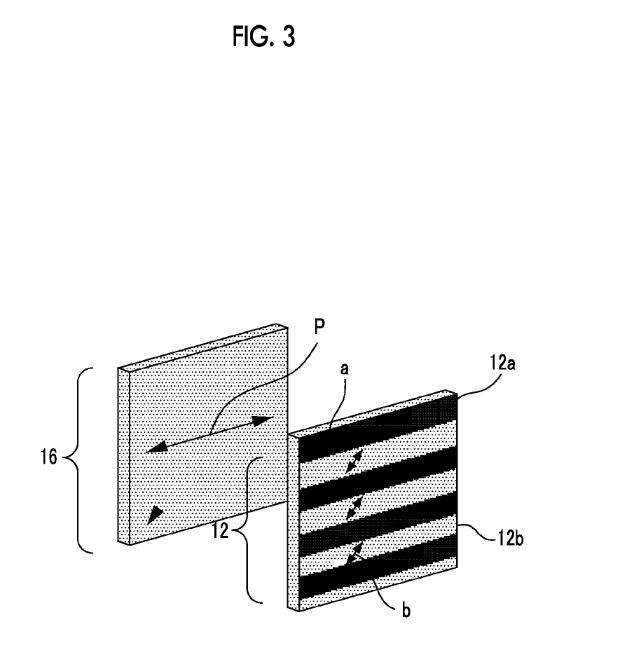

The optically anisotropic layer is a patterned optically anisotropic layer in which first and second phase difference areas are evenly and symmetrically disposed in the image display apparatus. An example is an optically anisotropic layer in which the inner surface retardations of the first and second phase difference areas are approximately λ/4 respectively, and the inner surface retarded axes cross orthogonally with each other respectively. In this example, the optically anisotropic layer 12 is disposed so that the inner surface retarded axes a and b of the first and second phase difference areas 12a and 12b are at ±45° with respect to the transmission axis P of the linear polarization layer 16 as shown in FIGS. 2 and 3. This configuration enables separation of right-eye and left-eye circularly polarized images. In addition, the view angle may be further enlarged by further laminating a λ/2 plate.

Circularly polarized images can also be separated similarly by using an optically anisotropic layer in which one of the first and second phase difference areas 12a and 12b has an inner surface retardation of λ/4, and the other has an inner surface retardation of 3λ/4. In addition, right-eye and left-eye linearly polarized images may be separated by using an optically anisotropic layer in which one of the first and second phase difference areas 12a and 12b has an inner surface retardation of λ/4, and the other has an inner surface retardation of 3λ/4.

Furthermore, circularly polarized images can also be separated similarly by using an optically anisotropic layer in which one of the first and second phase difference areas 12a and 12b has an inner surface retardation of λ/2, and the other has an inner surface retardation of 0, and laminating the optically anisotropic layer so that a transparent supporting body having an inner surface retardation of λ/4 and the respective retarded axes are in parallel or cross orthogonally with each other.

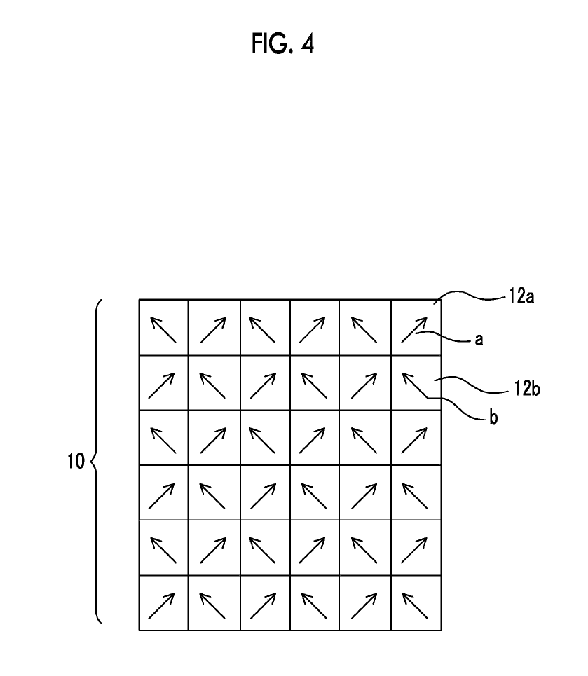

In addition, the shape and disposition pattern of the first and second phase difference areas 12a and 12b are not limited to an aspect in which the stripe patterns as shown in FIGS. 2 and 3 are alternately disposed. Rectangular patterns may be disposed in a grid shape as shown in FIG. 4.

The optically anisotropic layer 12 is formed of a composition having a liquid crystalline compound having a polarizable group as a main component, and the liquid crystalline compound is preferably oriented vertically. Meanwhile, in the specification, the “vertical orientation” indicates that, for example, the disc surface of the discotic liquid crystal and the layer surface are vertical to each other in a case in which the liquid crystalline compound is a discotic liquid crystal. In the specification, the vertical orientation does not require the disc surface of the discotic liquid crystal and the layer surface to be strictly vertical to each other, and means that the inclination angle formed with respect to the horizontal surface is 70 degrees or more. The inclination angle is preferably 85 degrees to 90 degrees, more preferably 87 degrees to 90 degrees, still more preferably 88 degrees to 90 degrees, and most preferably 89 degrees to 90 degrees. In addition, the patterned optically anisotropic layer may also contain an orientation controlling agent that controls the orientation of the liquid crystalline compound in the composition. The details of the liquid crystalline compound and the orientation controlling agent will be described below.

In the aspect in which the inner surface retardations of the first and second phase difference areas 12a and 12b are approximately λ/4 respectively, the inner surface retarded axes a and b preferably form angles of ±45° with respect to the transmission axis of the polarization film. In the specification, it is not necessary for both the first and second phase difference areas 12a and 12b to be strictly at ±450, but one is preferably at 40° to 50°, and the other is preferably at −50° to −40°.

Meanwhile, the Re of the optically anisotropic layer 12 does not need to be λ/4 singly, and the total of the Re of all members including the optically anisotropic layer 12 disposed on one surface of the polarization film 16 is preferably 110 nm to 160 nm, more preferably 120 nm to 150 nm, and particularly preferably 125 nm to 145 nm.

On the other hand, in a case in which the phase difference plate is disposed in the display panel, since the Rth of members disposed at the outside of the polarization film on the observation side affects view angle characteristics, the absolute value thereof is preferably lower, and, specifically, the Rth is preferably −100 nm to 100 nm, more preferably −60 nm to 60 nm, and particularly preferably −60 nm to 20 nm.

The image display panel portion has an observation-side polarization plate, a display panel, and a polarization plate in this order from the observation side.

In the invention, there is no limitation on the display panel. The display panel may be, for example, a liquid crystal panel including a liquid crystal layer, an organic EL display panel including an organic EL layer, or a plasma display panel. In any aspect, a variety of available configurations can be employed. In addition, in the case of a liquid crystal panel in a transparent mode or the like, in an aspect a polarization film is provided for image display on the observation-side surface, and the phase difference plate of the invention may achieve the above function in combination with the polarization film. It is needless to say that the phase difference plate of the invention may have a polarization film separately from the liquid crystal panel; however, in such a case, the phase different plate and the liquid crystal panel are disposed so that the transmission axis of the polarization film in the phase difference plate and the transmission axis of the polarization film in the liquid crystal panel coincide.

In a case in which the display panel is a liquid crystal cell, the display panel is configured in a transparent mode in which a back light is disposed behind the liquid crystal cell, and a polarization film is disposed between the back light and the liquid crystal cell.

The configuration of the liquid crystal cell is not particularly limited, and a liquid crystal cell having an ordinary configuration can be employed. The liquid crystal cell includes, for example, a pair of substrates disposed opposite, not shown, and a liquid crystal layer sandwiched between the pair of substrates, and may include a color filter layer and the like, if necessary. The driving mode of the liquid crystal cell is also not particularly limited, and a variety of modes, such as a twisted nematic (TN) mode, a super twisted nematic (STN) mode, a vertical alignment (VA) mode, an in-plane switching (IPS) mode, and an optically compensated birefringence (OCB) mode, can be used. In the TN mode, generally, the transmission axis of the polarization film is disposed at 45° or 135° with respect to 0° in the right and left directions of the display surface, and therefore a liquid crystal panel in the TN mode is preferably combined with a phase difference plate of the aspect as shown in FIG. 2. In addition, in the VA mode and the IPS mode, generally, the transmission axis of the polarization film is disposed at 0° or 90° with respect to 0° in the right and left directions of the display surface, and therefore a liquid crystal panel in the VA mode or the IPS mode is preferably combined with a phase difference plate of the aspect as shown in FIG. 3.

The polarization plate has an optical compensation film having a function of compensating the view angle of the display panel, such as the liquid crystal cell, on one surface of the polarization film and a protective film that protects the polarization film on the other surface.

In the invention, an adhesive composition having a glass transition temperature of room temperature or lower is coated between the image display panel portion and the phase difference plate, and the image display panel portion and the phase difference plate are adhered to each other through the adhesive composition. At least one of the surfaces adhered through the adhesive composition is a film including a cellulose derivative. For example, in FIG. 1A, the transparent supporting body in the phase difference plate and/or the protective film for the observation-side polarization plate need to be a film including a cellulose derivative. Details of the available members and the like will be described below.

In addition, in a case in which the polarization plate is provided on the surface of the image display panel portion on the observation side as shown in FIG. 1A, for example, the 3D image display apparatus may be an aspect in which the phase difference plate has an anti-reflection layer, a substrate film, the optically anisotropic layer, the transparent supporting body, the polarization film, and the optical compensation film laminated in this order from the observation side, and the image display panel portion has the display panel and the polarization plate laminated in this order from the observation side as shown in the example of FIG. 1C as well as an aspect in which the phase difference plate does not have the polarization plate. In addition, the 3D image display apparatus may be an aspect in which the phase difference plate has the anti-reflection layer, the transparent supporting body, the optically anisotropic layer, the polarization film, and the optical compensation film laminated in this order from the observation side, and the image display panel portion has the display panel and the polarization plate laminated in this order from the observation side as shown in FIG. 1D.

In the aspects of FIGS. 1C and 1D, the optical compensation film is a film including a cellulose derivative.

In addition, the 3D image display apparatus may be an aspect in which the phase difference plate has the anti-reflection layer, the transparent supporting body, the optically anisotropic layer, and an adhesive layer laminated in this order from the observation side, and the image display panel portion has the observation-side polarization plate, the display panel, and the polarization plate laminated in this order from the observation side as shown in FIG. 1B. In the aspect of FIG. 1B, the protective film for the observation-side polarization plate is a film including a cellulose derivative.

The phase difference plate may be an aspect in which an adhesive layer including the adhesive composition is provided on the surface on the opposite side of the observation side. This aspect enables adhesion of the image display panel portion and the phase difference plate through the adhesive layer.

In the aspect of FIG. 1A, the transparent supporting body in the phase difference plate and/or the protective film for the image display panel portion need to be a film including a cellulose derivative. In the aspect of FIG. 1B, the protective film for the image display panel portion needs to be a film including a cellulose derivative. In the aspects of FIGS. 1C and 1D, the optical compensation film in the phase difference plate needs to be a film including a cellulose derivative.

The invention relates to a 3D image display system. The phase difference plate is disposed on the observation side of the display panel, and has a function of converting images displayed by the image display panel portion to polarized images, such as right-eye and left-eye circularly polarized images or linearly polarized images. An observer observes the images through the polarization plate, such as circularly polarized or linearly polarized glasses, and recognizes the images as stereoscopic images.

The invention relates to a method of manufacturing the 3D image display apparatus of the invention. The adhesive composition having a glass transition temperature of room temperature or lower is coated between the image display panel portion and the phase difference plate, the image display panel portion and the phase difference plate are aligned in a state in which the adhesive composition is interposed, and then the adhesion composition is cured using an external stimulus, such as irradiation of ultraviolet rays, thereby adhering the image display panel portion and the phase difference plate.

In the invention, since the adhesive composition is made to have a predetermined viscosity, it is possible to align the image display panel portion and the phase difference plate before being adhered to each other. In addition, since the invention is excellent in terms of reworkability even after the adhesive composition is cured, it is possible to realign the image display panel portion and the phase difference plate, and to improve the yield.

In addition, the image display panel portion and the phase difference plate may be adhered to each other by using the phase difference plate having the adhesive layer on the surface opposite to the observation side.

Additionally, a deaerating process, a laminating process, and the like may be carried out before adhesion, and the processes can be carried out by well-known methods.

Hereinafter, a variety of members that are used in the 3D image display apparatus of the invention will be described in detail.

<Adhesive Composition>

The glass transition temperature of the adhesive composition for the 3D image display apparatus is room temperature or lower. When the glass transition temperature of the adhesive composition exceeds room temperature, it becomes difficult to follow the dimensional changes of the films. Here, room temperature refers to room temperature in a manufacturing environment, and varies with manufacturing environments. In addition, in order to obtain an excellent adhesion force and follow the dimensional changes of the films, the glass transition temperature of the adhesive is room temperature or lower, preferably −15° C. or lower, and more preferably −30° C. or lower.

In the invention, it is also possible to use the storage elastic modulus as the hardness index of the adhesive composition, similarly to the glass transition temperature. The storage elastic modulus G′ of the adhesive composition by the shear mode at 30° C. is preferably 1000 kPa or less, more preferably 500 kPa or less, and still more preferably 400 kPa or less. In addition, the storage elastic modulus of the adhesive composition is preferably 1 kPa or more from the viewpoint of the storage stability. That is, the storage elastic modulus of the adhesive composition is preferably in a range of 1000 kPa to 1 kPa, more preferably 500 kPa to 10 kPa, and still more preferably 400 kPa to 20 kPa. The storage elastic modulus can be obtained from dynamic viscoelastic behaviors obtained from measurements at 1 Hz using a dynamic viscoelastic measurement apparatus (for example, DVA-200, manufactured by IT Keisoku Seigyo Co., Ltd.). Furthermore, the loss tangent (tan δ) obtained by dynamic viscoelastic behaviors is preferably in a range of 1.0 to 0.003, more preferably in a range of 0.9 to 0.0035, and still more preferably in a range of 0.6 to 0.004 when measured at a frequency of 1 Hz and 30° C. in a tensile mode or shear mode.

As the adhesive composition, an adhesive that is liquid at room temperature to 40° C. is preferably used. It is preferable not to use a solvent, and, even when a solvent is used, the amount thereof preferably remains extremely small. The adhesive composition has a viscosity at a temperature of 25° C. of 0.1 cP to 1000 cP (0.1 mPa·s to 1000 mPa·s), more preferably 1 mPa·s to 750 mPa·s, and still more preferably 10 mPa·s to 500 mPa·s since alignment is possible without moving the phase difference plate and injecting air bubbles.

In addition, for viscosity adjustment, a polymer having a mass average molecular weight of 10000 or more can be used as the adhesive. In order to obtain a desired viscosity by adding a small amount of the adhesive, a polymer having a large molecular weight, that is, a polymer having a mass average molecular weight of 100000 or more is preferably used, and a polymer having a mass average molecular weight of one million or more is more preferably used. However, it is also possible to produce an adhesive composition having a preferable viscosity without using an adhesive by using a urethane (meth)acrylate-based macropolymer having, for example, the above preferable glass transition temperature, the preferable mass average molecular weight as described below, or the like.

In the invention, when the adhesive composition is formed of an ultraviolet curable composition which is cured by ultraviolet rays, an apparatus used for adhering the phase difference plate and the display panel becomes simple, furthermore, adhesion time can be shortened, and the adhesive composition can be manufactured at low cost. Thereby, the productivity can be improved. In addition, when an ultraviolet curable composition containing a urethane (meth)acrylate-based macromonomer is used as the ultraviolet curable composition, the adhesion force can be increased in spite of the low glass transition temperature. As described above, the adhesion force is decreased as the Tg of the ultraviolet curable composition of the related art is decreased. Polymers having a low glass transition temperature refer to polymers in which the intermolecular rotation of high molecular main chains is liable to occur due to micro Brownian motion, in other words, polymers having large free volumes around high molecular main chains. Due to the above, ordinarily, polymers having a low glass transition temperature have a weak cohesion force and a weak adhesion force. That is, when monomers for which the glass transition temperature is expected to be lowered are polymerized, it becomes possible to produce an adhesive composition having a weak cohesion force and a weak adhesion force. In contrast to the above, it is an extremely surprising fact that an ultraviolet curable composition having a strong adhesion force can be obtained by a urethane (meth)acrylate-based macromonomer being contained in spite of a low glass transition temperature.

In the invention, “(meth)acrylate” refers to chemicals including an ester of acrylic acid (acrylates) and an ester of methacrylic acid (methacrylates), and “urethane (meth)acrylate-based macromonomer” refers to urethane (meth)acrylates having a mass average molecular weight of 100 to 1×10⁷, and preferably urethane (meth)acrylates having a mass average molecular weight of 1000 to 1×10⁶, and more preferably 10000 to 100000.

The urethane (meth)acrylate-based macromonomer is preferably a monofunctional to pentafunctional macromonomer, more preferably a bifunctional to tetrafunctional macromonomer, and still more preferably a bifunctional to trifunctional macromonomer.

In addition, in order to produce an ultraviolet curable composition having favorable coating aptitude, it is preferable to use a macromonomer having a glass transition temperature of −10° C. or lower as the urethane (meth)acrylate-based macromonomer. When a urethane (meth)acrylate-based macromonomer having a glass transition temperature of −10° C. or lower is used, an ultraviolet curable, composition having an appropriate viscosity and favorable coating aptitude can be produced. The glass transition temperature of the urethane (meth)acrylate-based macromonomer is more preferably −15° C. to −100° C., and still more preferably −20° C. to −90° C.

The mass average molecular weight of the urethane (meth)acrylate-based macromonomer is preferably 100 to 1×10⁷, more preferably 1000 to 1×10⁶, and still more preferably 10000 to 100000. When the mass average molecular weight is in the above ranges, the ultraviolet curable composition having a preferable viscosity can be produced, and, furthermore, an ultraviolet curable composition having a glass transition temperature in a desired range after curing can be produced.

The urethane (meth)acrylate-based macromonomer can be produced by causing a reaction of a polyol compound, a polyisocyanate compound, and a hydroxyl group-containing (meth)acrylate compound. Alternately, the urethane (meth)acrylate-based macromonomer can be obtained from commercially available products. The commercially available products include urethane acrylates EBECRYL-230 (bifunctional, mass average molecular weight of 5000 (value from the catalog of manufacturer), Tg; −55° C.), EBECRYL-270 (bifunctional, mass average molecular weight of 1500, Tg; −27° C.), KRM8296 (trifunctional, Tg; −11° C.), all of which are manufactured by Daicel-Cytec Company Ltd., and the like, but the invention is not limited thereto.

Hereinafter, the respective components that can be used as raw materials of the urethane (meth)acrylate-based macromonomer will be described.

(i) Polyol Compound

As the polyol compound, polyether polyols, polyester polyols, polycarbonate polyols, polycaprolactone polyols, aliphatic hydrocarbons having two or more hydroxyl groups in the molecules, alicyclic hydrocarbons having two or more hydroxyl groups in the molecules, unsaturated hydrocarbons having two or more hydroxyl groups in the molecules, and the like can be used. The polyol can be used singly or jointly used in combination of two or more kinds.

The polyether polyols include aliphatic polyether polyols, alicyclic polyether polyols, and aromatic polyether polyols.

Here, examples of the aliphatic polyether polyols include multivalent alcohols, such as polyethylene glycol, polypropylene glycol, polytetramethylene glycol, polyhexamethylene glycol, polyheptamethylene glycol, polydecamethylene glycol, pentaerythritol, dipentaerythritol, trimethylolpropane, alkylene oxide adducts of polyols, such as ethylene oxide adduct triols of trimethylolpropane, propylene oxide adduct triols of trimethylolpropane, ethylene oxide and propylene oxide adduct triols of trimethylolpropane, ethylene oxide adducts of tetraols of pentaerythritol, and ethylene oxide adducts of hexaols of dipentaerythritol, and polyether polyols obtained by open-ring polymerization of two or more kinds of ion-polymerizable cyclic compounds.

Examples of the ion-polymerizable cyclic compounds include cyclic ethers, such as ethylene oxide, propylene oxide, butene-1-oxide, isobutene oxide, 3,3-bis(chloromethyl)oxetane, tetrahydrofuran, 2-methyltetrahydrofuran, dioxane, trioxane, tetraoxane, cyclohexene oxide, styrene oxide, epichlorohydrin, glycidyl ether, allyl glycidyl ether, allyl glycidyl carbonate, butadiene monoxide, isoprene monoxide, vinyloxetane, vinyltetrahydrofuran, vinylcyclohexene oxide, phenyl glycidyl ether, butyl glycidyl ether, glycidyl benzoate, and the like. Specific combinations of two or more kinds of ion-polymerizable cyclic compounds include tetrahydrofuran and ethylene oxide, tetrahydrofuran and propylene oxide, tetrahydrofuran and 2-methyltetrahydrofuran, tetrahydrofuran and 3-methyltetrahydrofuran, ethylene oxide and propylene oxide, butene-1-oxide and ethylene oxide, tetrahydrofuran, butene-1-oxide, and ethylene oxide, and the like.

In addition, it is also possible to use a polyether polyol obtained by ring-opening copolymerization of the ion-polymerizable cyclic compound and a cyclic imine, such as ethyleneimine, a cyclic lactonic acid, such as 3-propiolactone or glycolic acid lactide, or a dimethylcyclopolysiloxane.

Examples of the aliphatic polyether polyols include alkylene oxide adduct diols of hydrogenated bisphenol A, alkylene oxide adduct diols of hydrogenated bisphenol F, alkylene oxide adduct diols of 1,4-cyclohexanediol, and the like.

Examples of the aromatic polyether polyols include alkylene oxide adduct diols of bisphenol A, alkylene oxide adduct diols of bisphenol F, alkylene oxide adduct diols of hydroquinone, alkylene oxide adduct diols of naphthohydroquinone, alkylene oxide adduct diols of anthrahydroquinone, and the like.

Examples of the commercially available products of the polyether polyols include PTMG 650, PTMG 1000, PTMG 2000 (all manufactured by Mitsubishi Chemical Corp.), PPG 1000, EXCENOL 1020, EXCENOL 2020, EXCENOL 3020, EXCENOL 4020 (all manufactured by Asahi Glass Urethane Co., Ltd.), PEG 1000, UNISAFE DC1100, UNISAFE DC1800, UNISAFE DCB1100, UNISAFE DCB1800 (all manufactured by Nippon Oil and Fats Co., Ltd.), PPTG 1000, PPTG 2000, PPTG 4000, PTG 400, PTG 650, PTG 2000, PTG 3000, PTGL 1000, PTGL 2000 (all manufactured by Hodogaya Chemical Co., Ltd.), PPG 400, PBG 400, Z-3001-4, Z-3001-5, PBG 2000, PBG 2000B (all manufactured by Daiichi Kogyo Seiyaku Co., Ltd.), TMP30, PNT4 GLYCOL, EDA P4, EDA P8 (all manufactured by Nippon Nyukazai Co., Ltd.), and QUADROL (manufactured by Adeka Corporation). Examples of the aromatic polyether polyols include UNIOL DA400, DA700, DA1000, DB400 (all manufactured by Nippon Oil and Fats Co., Ltd.), and the like.

In addition, the polyester polyol can be obtained by reacting a multivalent alcohol and a dibasic acid. Here, the multivalent alcohol includes ethylene glycol, polyethylene glycol, propylene glycol, polypropylene glycol, tetramethylene glycol, polytetramethylene glycol, 1,4-butanediol, 1,5-pentanediol, 1,6-hexanediol, 1,7-heptanediol, 1,8-octanediol, neopentyl glycol, 1,4-cyclohexanediol, 1,4-cyclohexanedimethanol, 1,2-bis(hydroxyethyl)cyclohexane, 2,2-diethyl-1,3-propanediol, 3-methyl-1,5-pentane polyol, 1,9-nonane polyol, 2-methyl-1,8-octane polyol, glycerin, trimethylolpropane, ethylene oxide adducts of trimethylolpropane, propylene oxide adducts of trimethylolpropane, ethylene oxide and propylene oxide adducts of trimethylolpropane, and, sorbitol, pentaerythritol, dipentaerythritol, alkylene oxide adducts of polyols, and the like. In addition, examples of the dibasic acid include phthalic acid, isophthalic acid, terephthalic acid, maleic acid, fumaric acid, adipic acid, sebacic acid, and the like. The commercially available products of the polyester polyol which can be used include KURAPOL P1010, KURAPOL P2010, PMIPA, PKA-A, PKA-A2, PNA-2000 (manufactured by Kuraray Co., Ltd.), and the like.

In addition, examples of the polycarbonate polyol include polycarbonate diols represented by the following general formula (1).

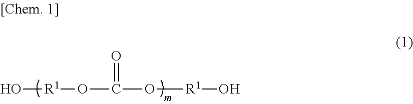

In the general formula (1), R¹ represents an alkylene group, a (poly)ethylene glycol residue, a (poly)propylene glycol residue, or a (poly)tetramethylene glycol residue which have 2 to 20 carbon atoms, and m represents an integer in a range of 1 to 30.

Specific examples of R¹ include residues obtained by removing hydroxyl groups at both ends from the following compounds, that is, residues obtained by removing hydroxyl groups from 1,4-butanediol, 1,5-pentanediol, neopentyl glycol, 1,6-hexanediol, 1,4-cyclohexanedimethanol, 1,7-heptanediol, 1,8-octanediol, 1,9-nonanediol, ethylene glycol, diethylene glycol, triethylene glycol, tetraethylene glycol, propylene glycol, dipropylene glycol, tripropylene glycol, tetrapropylene glycol, and the like. Commercially available products of the polycarbonate polyol include DN-980, DN-981, DN-982, DN-983 (all manufactured by Nippon Polyurethane Industry Co., Ltd.), PC-8000 (manufactured by PPG), PNOC 1000, PNOC 2000, PMC 100, PMC 2000 (all manufactured by Kuraray Co., Ltd.), PLACCEL CD-205, CD-208, CD-210, CD-220, CD-205PL, CD-208PL, CD-210PL CD-220PL, CD-205HL, CD-208HL, CD-210HL, CD-220HL, CD-210T, CD-221T (all manufactured by Diacel Corporation), and the like.

The polycaprolactone polyol includes polycaprolactone diols obtained by causing an addition reaction of ∈-caprolactone to a diol, such as ethylene glycol, propylene glycol, polyethylene glycol, tetramethylene glycol, polytetramethylene glycol, 1,2-polybutylene glycol, 1,6-hexanediol, neopentyl glycol, 1,4-cyclohexanedimethanol, or 1,4-butanediol. The commercially available products thereof that can be used include PLACCEL 205, 205AL, 212, 212AL, 220, 220AL (all manufactured by Daicel Chemical Industries, Ltd.), and the like.

The aliphatic hydrocarbon having two or more hydroxyl groups in the molecules include ethylene glycol, propylene glycol, 1,4-butanediol, 1,5-pentanediol, 1,6-hexanediol, 1,7-heptanediol, 1,8-octanediol, 1,9-nonanediol, neopentyl glycol, 2,2-diethyl-1,3-propanediol, 3-methyl-1,5-pentanediol, 2-methyl-1,8-octanediol, hydroxy-terminated hydrogenated polybutadiene, glycerin, trimethylolpropane, pentaerythritol, sorbitol, and the like.

Examples of the alicyclic hydrocarbon having two or more hydroxyl groups in the molecules include 1,4-cyclohexanediol, 1,4-cyclohexanedimethanol, 1,2-bis(hydroxyethyl)cyclohexane, dimethylol compounds of dicyclopentadiene, tricyclodecane methanol, and the like.

Examples of the unsaturated hydrocarbon having two or more hydroxyl groups in the molecules include hydroxyl-terminated polybutadiene, hydroxyl-terminated polyisoprene, and the like.

Furthermore, examples of other polyols include β-methyl-δ-valerolactonediol, ricinus-modified diol, terminated diol compounds of polydimethylsiloxane, polydimethyl siloxane carbitol-modified diol, and the like.

The mass average molecular weight of the polyol compound is preferably 1000 to 10000, and particularly preferably 1000 to 9000. The mass average molecular weight is a value obtained by dissolving a part of a polymer in tetrahydrofuran (THF) and measuring a molecular weight using gel permeation chromatography (GPC). In the invention, the mass average molecular weight is a value for which polystyrene is used as a standard substance.

The most preferable polyol compound includes polypropylene glycol in terms of solubility.

(ii) Polyisocyanate Compound

Diisocyanate compounds are preferable as the polyisocyanate compound, and examples thereof include 2,4-tolylene diisocyanate, 2,6-tolylene diisocyanate, 1,3-xylylene diisocyanate, 1,4-xylylene diisocyanate, 1,5-naphthalene diisocyanate, m-phenyl diisocyanate, p-phenylene diisocyanate, 3,3′-dimethyl-4,4′-diphenylmethane diisocyanate, 4,4′-diphenylmethane diisocyanate, 3,3′-dimethylphenylene diisocyanate, 4,4′-biphenylene diisocyanate, 1,6-hexane diisocyanate, isophorone dicyanate, 2,2,4-trimethylhexamethylene diisocyanate, bis(2-isocyanate ethyl) fumarate, 6-isopropyl-1,3-phenyl diisocyanate, 4-diphenylpropane diisocyanate, lysine isocyanate, hydrogenated diphenylmethane diisocyanate (for example, 4,4′-dicyclohexyl diisocyanate, and the like), hydrogenated xylylene diisocyanate, tetramethyl xylylene diisocyanate, and the like. Among them, 2,4-tolylene diisocyanate, 2,6-tolylene diisocyanate, hydrogenated xylylene diisocyanate, isophorone dicyanate, hydrogenated diphenylethane diisocyanate, and the like are particularly preferred. The diisocyanate can be used singly or in combination of two or more kinds.

(iii) Hydroxyl Group-Containing (Meth)Acrylate Compound

The hydroxyl group-containing (meth)acrylate compound is a (meth)acrylate having a hydroxyl group at an ester residue, that is, a monohydroxy (meth)acrylate obtained by causing a reaction of a bifunctional alcohol, such as ethylene glycol, 1,3-butylene glycol, 1,4-butanediol, 1,5-pentanediol, 3-methyl-1,5-pentanediol, 1,6-hexanediol, neopentyl glycol, 1,8-octanediol, 1,9-nonanediol, tricyclodecane dimethanol, ethylene glycol, polyethylene glycol (the mass average molecular weight is, for example, 200 to 9000, preferably 1000 to 9000, and more preferably 2000 to 8000), propylene glycol, dipropylene glycol, tripropylene glycol, or polypropylene glycol (the mass average molecular weight is, for example, 200 to 9000, preferably 1000 to 9000, and more preferably 2000 to 8000), with (meth)acrylic acid. Examples thereof include 2-hydroxy ethyl (meth)acrylate, 2-hydroxy propyl (meth)acrylate, 4-hydroxy butyl (meth)acrylate, 2-hydroxy-3-phenyloxy propyl (meth)acrylate, 1,4-butanediol mono(meth)acrylate, 2-hydroxy alkyl (meth)acryloyl phosphate, 4-hydroxy cyclohexyl (meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate, (meth)acrylates represented by the following structural formula (2), and the like.

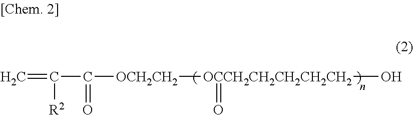

[In the general formula (2), R² represents a hydrogen atom or a methyl group, and n represents an integer in a range of 1 to 15, and preferably 1 to 4.] Furthermore, examples thereof also include compounds obtained by an addition reaction of a glycidyl group-containing compound, such as alkyl glycidyl ether, allyl glycidyl ether, or glycidyl (meth)acrylate, and (meth)acrylic acid. Among them, hydroxyl alkyl (meth)acrylates, such as 2-hydroxy ethyl (meth)acrylate, 2-hydroxy propyl (meth)acrylate, and 4-hydroxy butyl (meth)acrylate, are particularly preferred.

A method of synthesizing the urethane (meth)acrylate-based macromonomer is not particularly limited, and examples thereof include the following methods (i) to (iii).

(i) A method in which (b) polyisocyanate and (c) hydroxyl group-containing (meth)acrylate are made to react with each other, and, subsequently, (a) polyol is made to react.

(ii) A method in which (a) polyol, (b) polyisocyanate, and (c) hydroxyl group-containing (meth)acrylate are prepared all together and made to react with one another.

(iii) A method in which (a) polyol and (b) polyisocyanate are made to react with each other, and, subsequently, (c) hydroxyl group-containing (meth)acrylate is made to react.

In the synthesis of urethane (meth)acrylate that is used in the invention, generally, it is preferable to use 0.01 parts by mass to 1 part by mass of a urethanification catalyst, such as copper naphthenate, cobalt naphthenate, zinc naphthenate, di-n-butyltin dilaurate, triethyl amine, 1,4-diazabicyclo[2.2.2]octane, or 1,4-diaza-2-methylbicyclo[2.2.2]octane, with respect to a total amount of 100 parts by mass of reactants. The reaction temperature in the reaction is ordinarily 0° C. to 90° C., and preferably 10° C. to 80° C.

The urethane (meth)acrylate-based macromonomer that is preferred from the viewpoint of producing the ultraviolet-curable composition having preferable coating aptitude includes the following (A) and (B).

(A) Reaction products of a polyol compound having a mass average molecular weight of 1000 to 10000, a polyisocyanate compound, and a hydroxyl group-containing (meth)acrylate compound.

(B) Reaction products of a polyol compound, a polyisocyanate compound, and a hydroxyl group-containing (meth)acrylate compound having a mass average molecular weight of 1000 to 10000.

The proportion of the urethane (meth)acrylate-based macromonomer in 100 parts by mass of a composition is preferably 10 parts by mass to 80 parts by mass, more preferably 15 parts by mass to 75 parts by mass, and still more preferably 20 parts by mass to 70 parts by mass in terms of the glass transition temperature of an intermediate layer being formed and the viscosity of the ultraviolet-curable composition. Meanwhile, the urethane (meth)acrylate-based macromonomer may be used singly or in combination of two or more kinds.

The ultraviolet-curable composition includes urethane (meth)acrylate-based macromonomers and polymerizable monomer components of monofunctional (meth)acrylates, multifunctional (meth)acrylates, and the like. The ultraviolet-curable composition may be used singly or in combination of two or more kinds. The polymerizable monomers include acrylates represented by the following general formula (a) and methacrylates represented by the following general formula (b).

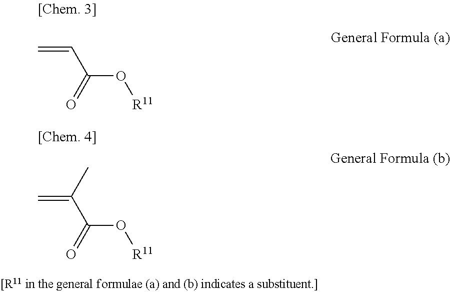

More specifically, examples of the polymerizable monomers that can be used in the invention include the following: examples of the monofunctional (meth)acrylate include (meth)acrylates having a substituent, in which examples of the substituent R¹¹ in the general formulae (a) and (b) includes a methyl group, an ethyl group, a propyl group, a butyl group, a sec-butyl group, a tert-butyl group, a pentyl group, a hexyl group, a heptyl group, a 2-ethyl hexyl group, an octyl group, a nonyl group, a dodecyl group, a hexadecyl group, an octadecyl group, a cyclohexyl group, a benzyl group, a methoxy ethyl group, a butoxy ethyl group, a phenoxy ethyl group, a nonyl phenoxy ethyl group, a tetrahydrofurfuryl group, a glycidyl group, a 2-hydroxy ethyl group, a 2-hydroxy propyl group, a 3-chloro-2-hydroxy propyl group, a dimethyl amino ethyl group, a diethyl amino ethyl group, a nonyl phenoxy ethyl tetrahydrofurfuryl group, a caprolactone-modified tetrahydrofurfuryl group, an isobornyl group, a dicyclopentanyl group, a dicyclopentenyl group, or a dicyclopentenyloxy ethyl group, and the like, and, furthermore, includes (meth)acrylic acid.

The preferred substituent R¹¹ includes a butyl group, a pentyl group, a hexyl group, a heptyl group, a 2-ethyl hexyl group, an octyl group, a nonyl group, and a dodecyl group, and a more preferred monomer includes butyl acrylate, hexyl acrylate, 2-ethyl hexyl acrylate, octyl acrylate, nonyl acrylate, and dodecyl methacrylate.

In addition, examples of the multifunctional (meth)acrylate include diacrylates, such as 1,3-butylene glycol, 1,4-butanediol, 1,5-pentanediol, 3-methyl-1,5-pentanediol, 1,6-hexanediol, neopentyl glycol, 1,8-octanediol, 1,9-nonanediol, tricylcodecane methanol, ethylene glycol, polyethylene glycol, propylene glycol, dipropylene glycol, tripropylene glycol, or polypropylene glycol, di(meth)acrylates of tris(2-hydroxyethyl) isocyanurate, di(meth)acrylates of diols obtained by adding 4 or more moles of ethylene oxide or propylene oxide to 1 mole of neopentyl glycol, di(meth)acrylates of diols obtained by adding 2 moles of ethylene oxide or propylene oxide to 1 mole of bisphenol A, trimethylolpropane tri(meth)acrylate, di- or tri(meth)acrylates of triols obtained by adding 3 or more moles of ethylene oxide or propylene oxide to 1 mole of trimethylolpropane, di(meth)acrylates of diols obtained by adding 4 or more moles of ethylene oxide or propylene oxide to 1 mole of bisphenol A, tris(2-hydroxyethyl)isocyanurate tri(meth)acrylate, tri(meth)acrylates obtained by adding 3 or more moles of ethylene oxide or propylene oxide to 1 mole of tris(2-hydroxyethyl)isocyanurate, pentaerythritol or tetra(meth)acrylate, tri- or tetra(meth)acrylates obtained by adding 4 or more moles of ethylene oxide or propylene oxide to 1 mole of pentaerythritol, poly(meth)acrylates of dipentaerythritol, poly(meth)acrylates obtained by adding 6 or more moles of ethylene oxide or propylene oxide to 1 mole of dipentaerythritol, caprolactone-modified tris[(meth)acryloxy ethyl]isocyanurate, poly(meth)acrylates of alkyl-modified dipentaerythritol, poly(meth)acrylates of caprolactone-modified pentaerythritol, hydroxyl pivalic acid neopentyl glycol diacrylate, caprolactone-modified hydroxyl pivalic acid neopentyl glycol diacrylate, ethylene oxide-modified phosphoric acid (meth)acrylate, ethylene oxide-modified alkylated phosphoric acid (meth)acrylate, and the like.

Preferred examples thereof include di(meth)acrylates of diols obtained by adding 4 or more moles of ethylene oxide or propylene oxide to 1 mole of bisphenol A, di- or tri(meth)acrylates of triols obtained by adding 3 or more moles of ethylene oxide or propylene oxide to 1 mole of trimethylolpropane, tri(meth)acrylates obtained by adding 3 or more moles of ethylene oxide or propylene oxide to 1 mole of tris(2-hydroxyethyl) isocyanurate, tetra(meth)acrylates obtained by adding 4 or more moles of ethylene oxide or propylene oxide to 1 mole of pentaerythritol, and poly(meth)acrylates obtained by adding 6 or more moles of ethylene oxide or propylene oxide to 1 mole of dipentaerythritol, and more preferred examples thereof include di(meth)acrylates of diols obtained by adding 4 or more moles of ethylene oxide or propylene oxide to 1 mole of bisphenol A, di- or tri(meth)acrylates of triols obtained by adding 3 or more moles of ethylene oxide or propylene oxide to 1 mole of trimethylolpropane, and tri- or tetra(meth)acrylates obtained by adding 4 or more moles of ethylene oxide or propylene oxide to 1 mole of pentaerythritol.

In addition, N-vinyl-2-pyrrolidone, acryloylmorpholine, vinyl imidazole, N-vinyl caprolactame, N-vinyl formamide, vinyl acetate, (meth)acrylic acid, (meth)acrylamide, N-hydroxymethyl acrylamide, N-hydroxyethyl acrylamide, and alkyl ether compounds thereof can also be used.

Furthermore, polymerizable oligomers can also be used as the ultraviolet-curable compound. The polymerizable oligomers include polyester (meth)acrylate, polyether (meth)acrylate, epoxy (meth)acrylate, urethane (meth)acrylate, and the like.

The content of the polymerizable compound that is jointly used in the ultraviolet curable composition is preferably 90 parts by mass to 20 parts by mass, more preferably 85 parts by mass to 25 parts by mass, and still more preferably 80 parts by mass to 30 parts by mass with respect to 100 parts by mass of the ultraviolet curable composition.

Generally, a photopolymerization initiator is added to the ultraviolet curable composition. The photopolymerization initiator is not particularly limited as long as an ultraviolet curable compound represented by a polymerizable monomer and/or a polymerizable oligomer being used can be cured. Molecule cleavable or hydrogen abstraction photopolymerization initiators are preferred as the photopolymerization initiator in the invention.

The photopolymerization initiator is preferably benzoin isobutyl ether, 2,4-diethyl thioxanthone, 2-isopropyl thioxanthone, 2-chlorothioxanthone, benzil, 2,2-dimethoxy-2-phenylacetephenone, 2,4,6-trimethyl benzoyl diphenyl phosphine oxide, 2-benzyl-2-dimethyl amino-1-(4-morpholinophenyl)-butane-1-one, bis(2,6-dimethoxy benzoyl)-2,4,4-trimethyl pentyl phosphine oxide, or the like. Furthermore, as a molecule cleavable photopolymerization initiator other than the above, 1-hydroxy cyclohexyl phenyl ketone, benzoyl ethyl ether, benzyl dimethyl ketal, 2-hydroxy-2-methyl-1-phenyl-propane-1-one, 1-(4-isopropylphenyl)-2-hydroxy-2-methypropane-1-one, 2-methyl-4′-(methylthio)-2-morpholinopropiophenone, or the like may be jointly used, and, furthermore, benzophenone, 4-phenyl benzophenone, isophthalophenone, 4-benzoyl-4′-methyl-diphenyl sulfide, and the like, which are hydrogen abstraction photopolymerization initiators, may also be jointly used.

The photopolymerization initiator is preferably 2,4-diethyl thioxanthone, 2-isopropyl thioxanthone, 2-chlorothioxanthone, 2,2-dimethoxy-2-phenylacetephenone, 2,4,6-trimethyl benzoyl diphenyl phosphine oxide, 1-hydroxy cyclohexyl phenyl ketone, 2-methyl-4′-(methylthio)-2-morpholinopropiophenone, 4-phenylbenzophenone, and more preferably 2-isopropyl thioxanthone, 2,4,6-trimethyl benzoyl diphenyl phosphine oxide, 1-hydroxy cyclohexyl phenyl ketone, 2-methyl-4′-(methylthio)-2-morpholinopropiophenone, or 4-phenylbenzophenone.

In addition, it is also possible to jointly use amines that do not cause an addition polymerization reaction with the above polymerizable components, for example, triethylamine, methyl diethanolamine, triethanolamine, p-diethylaminoacetophenone, p-dimethylaminoacetophenone, ethyl p-dimethylamino benzoate, amyl p-dimethylamino benzoate, N,N-dimethylbenzylamine, 4,4′-bis(diethylamino)benzophenone, and the like, as a sensitizer with respect to the photopolymerization initiator. Naturally, it is preferable to select and use the photopolymerization initiator or sensitizer that is excellent in terms of the solubility in the curable components, and does not impair ultraviolet permeability.

In addition, it is also possible to further mix in a thermal polymerization inhibitor, an oxidation inhibitor represented by a hindered phenol, hindered amine, phosphide, and the like, a plasticizer, a silane coupling agent represented by epoxy silane, mercapto silane, (meth)acryl silane, and the like, and the like as additional additives, according to necessity, in the ultraviolet curable composition to improve a variety of characteristics. When the additives are used, it is preferable to differentiate additives that are excellent in terms of the solubility in curable components and additives that do not impair ultraviolet transmission.

The amounts of the photopolymerization initiator, the sensitizer and the variety of additives used in the ultraviolet curable composition can be appropriately set.

The irradiance level of ultraviolet rays irradiated for curing of the adhesive composition is preferably more than 200 mJ/cm², and more preferably in a range of 200 mJ/cm² to 2000 mJ/cm². Examples of UV lamps that can be used for curing include a metal halide lamp M02-L31 (manufactured by Eye Graphics Co., Ltd., cold mirror-attached, a lamp output of 120 W/cm), a 4.2 inch-spiral lamp, manufactured by Xenon Corporation, and the like. The distance between the lamp surface and a sample surface during irradiation of ultraviolet rays is preferably set appropriately.

In order to move a medium on which the ultraviolet curable composition is coated to an UV irradiating location (for example, moving from a spin table to an UV irradiation table), it is desirable to hold a substrate at the outer circumferential portion or inner circumferential portion of the medium, raise and move the medium. When the medium is supported from the top by a method of absorption or the like and raised, since the ultraviolet curable composition is not cured, there is a possibility that the medium is deformed or air bubbles are generated in the adhesive composition such that the film thickness variation or defects of the adhesive composition may be caused. In a case in which the substrate is held at the outer circumferential portion and moved, it is preferable to clean the supporting member on a regular basis. There are cases in which uncured ultraviolet curable composition is shaken off and attached to the outer circumferential edge portion during spinning, and the uncured ultraviolet curable composition is attached to the supporting member. When the medium is repetitively moved by the same supporting member, there is a possibility that the uncured ultraviolet curable composition may be attached to the medium from the supporting member, and defects may be caused.

In addition, in the UV irradiation location (for example, on the UV irradiation table), one portion or a plurality of portions of the inner circumferential portion, outer circumferential portion, intermediate circumferential portion, and the like of the substrate (medium) can be supported as portions at which the medium is supported. The entire surface may be uniformly supported by a plate-shaped supporting member. In a case in which a plurality of portions is supported, the supporting heights of the respective members can be changed. This is a case in which the outer circumferential portion is also supported and suppressed from hanging so that warpage after curing is suppressed in a case in which, for example, only the inner circumference is supported, the outer circumferential portion of the medium which is not supported hangs down due to its own weight, and the medium is cured in a hung shape, thereby causing warpage of the medium after curing, and an effect of adjusting the medium shape after curing by adjusting the heights of the respective supporting members can be expected.

The ultraviolet curable composition can have high transmittance even after being cured. According to the ultraviolet curable composition, it is possible to form an adhesive composition having a transmittance of, for example, 100% to 80%, which are values measured by the method as described in the examples as described below.

The thickness of the adhesive layer is preferably in a range of 0.1 μm to 100 μm, more preferably in a range of 0.5 μm to 50 μm, and more preferably in a range of 1 μm to 30 μm from the viewpoint of satisfying both reworkability and adhesion force.

The volume shrinkage rate of the ultraviolet curable composition after being cured is preferably 0.01% to 15%, more preferably 0.01% to 10%, and particularly preferably 0.01% to 5% from the viewpoint of following the dimensional changes of the transparent supporting body film and the like.

<Cellulose Derivative>

The 3D image display apparatus of the invention has the films including a cellulose derivative adhered through the adhesive composition, and thus has a high adhesion force in spite of a low glass transition temperature. Therefore, at least one of the films that are in contact with the adhesive layer needs to be a film including a cellulose derivative.

As the cellulose derivative, cellulose-based polymers that have been used as the transparent protective film for the polarization plate of the related art and are represented by triacetyl cellulose (hereinafter referred to as the cellulose acylate) can be preferably used. Hereinafter, mainly the cellulose acylate will be described in detail, but it is evident that the technical aspects thereof can be similarly applied to other polymer films.

(Cellulose Acylate Film)

Cellulose, which is a raw material of the cellulose acylate, includes cotton linter, wood pulp (hardwood pulp and softwood pulp), and the like, the cellulose acylate obtained from any raw material cellulose can be used, and the cellulose acylate may be used as a mixture if necessary. Details of the raw material cellulose are described in, for example, “Plastic Material Lecture (17) Cellulose-Based Resins” (Marusawa and Uda, published by Nikkan Kogyo Shinbun, 1970), and Hatsumei Kyokai Disclosure Bulletin No. 2001-1745 (pages 7 to 8), but the invention is not limited to the above description.

Next, the cellulose acylate manufactured using the above cellulose as a raw material will be described. The cellulose acylate is a cellulose in which the hydroxyl group is acylated, and any of cellulose acylates in which the substituent is an acetyl group having 2 to 22 carbon atoms in the acyl group can be used. With regard to the cellulose acylate, the substitution degree of cellulose with respect to hydroxyl groups is not particularly limited, and the substitution degree can be obtained by measuring and calculating the binding degree of an acetic acid and/or an aliphatic acid having 3 to 22 carbon atoms which is substituted at the hydroxyl group of the cellulose. A measurement method can be carried out according to ASTM D-817-91.

In the above cellulose acylate, the substitution degree of cellulose with respect to hydroxyl groups is not particularly limited, but the acyl substitution degree of cellulose with respect to hydroxyl groups is desirably 2.00 to 3.00, more desirably 2.75 to 3.00, and still more preferably 2.85 to 3.00.

Of the acetic acid and/or the aliphatic acid having 3 to 22 carbon atoms which is substituted at the hydroxyl group of the cellulose, the acyl group having 2 to 22 carbon atoms may be an aliphatic group or an aromatic group, and is not particularly limited. The acyl group may also be a single composition or a mixture of two or more kinds. Examples thereof include alkyl carbonyl esters, alkenyl carbonyl esters, aromatic carbonyl esters, aromatic alkyl carbonyl esters, and the like of cellulose, and may further include substituted groups thereof. The preferable acyl group thereof includes an acetyl group, a propionyl group, a butanoyl group, a heptanoyl group, a hexanoyl group, an octanoyl group, a decanoyl group, a dodecanoyl group, a tridecanoyl group, a tetradecanoyl group, a hexadecanoyl group, an octadecanoyl group, an iso-butanoyl group, a t-butanoyl group, a cyclohexane carbonoyl group, an oleoyl group, a benzoyl group, a naphthyl carbonyl group, a cinnamoyl group, and the like. Among them, an acetyl group, a propionyl group, a butanoyl group, a dodecanoyl group, an octadecanoyl group, a t-butanoyl group, an oleoyl group, a benzoyl group, a naphthyl carbonyl group, a cinnamoyl group, and the like are preferred, and an acetyl group, a propionyl group, and a butanoyl group are more preferred.

As a result of thorough studies by the inventors, it was found that the optical anisotropy of the cellulose acylate film can be degraded when the substitution degree is 2.50 to 3.00 in a case in which the acyl substituent that substitutes the hydroxyl group of the cellulose is composed of substantially at least two kinds of an acetyl group/a propionyl group/a butanoyl group. The substitution degree is more preferably 2.60 to 3.00, and more desirably 2.65 to 3.00. In addition, in a case in which the acyl substituent that substitutes the hydroxyl group of the cellulose is composed only of an acetyl group, the substitution degree is preferably 2.80 to 2.99, and more preferably 2.85 to 2.95 from the viewpoint of the compatibility with additives and the solubility in an organic solvent being used as well as the degradation of the optical anisotropy of the film.

The polymerization degree of the cellulose acylate that is preferably used in the invention is 180 to 700 in terms of the viscosity average polymerization degree, and the polymerization degree is more preferably 180 to 550, still more preferably 180 to 400, and particularly preferably 180 to 350 for cellulose acetate. When the polymerization degree is too high, the viscosity of a dope solution of the cellulose acylate is increased, and it becomes difficult to manufacture films through casting. When the polymerization degree is too low, the strength of the manufactured film is lowered. The average polymerization degree can be measured by the limiting viscosity method (Kazuo Uda and Hideo Saito; Sen'i Gakkaishi, Vol. 18, No. 1, pages 105 to 120, 1962), which is described in detail in JP1997-95538A (JP-H9-95538).

In addition, the molecular weight distribution of the cellulose acylate that is preferably used in the invention is evaluated by gel permeation chromatography, and it is preferable that the polydispersity index Mw/Mn (Mw represents a weight average molecular weight, and Mn represents a number average molecular weight) be small, and the molecular weight distribution be narrow. The specific value of the Mw/Mn is preferably 1.0 to 3.0, more preferably 1.0 to 2.0, and most preferably 1.0 to 1.6.

Removal of low molecular components is useful since the viscosity becomes lower than that of an ordinary cellulose acylate while the average molecular weight (polymerization degree) is increased. A cellulose acylate having a small amount of low molecular components can be obtained by removing low molecular components from the cellulose acylate that is synthesized by an ordinary method. The low molecular components can be removed by washing the cellulose acylate with an appropriate organic solvent. Meanwhile, in a case in which the cellulose acylate having a small amount of low molecular components is manufactured, the amount of a sulfuric acid catalyst in the acetylation reaction is preferably adjusted to 0.5 parts by mass to 25 parts by mass with respect to 100 parts by mass of cellulose. When the amount of the sulfuric acid catalyst is in the above ranges, it is possible to synthesize a cellulose acylate (having a uniform molecular weight distribution) which is also preferred in terms of the molecular weight distribution. When the cellulose acylate is manufactured, the moisture content is preferably 2% by mass or less, more preferably 1% by mass or less, and particularly preferably 0.7% by mass or less. Generally, a cellulose acylate is known to contain water at a moisture content of 2.5% by mass to 5% by mass. In the invention, drying is required to obtain a moisture content of the cellulose acylate in the above ranges, and the method is not particularly limited as long as the target moisture content can be obtained. A synthesis method of the cellulose acylate of the invention is described in detail on 7 to 12 pages in the Journal of Technical Disclosure by Japan Institute of Invention and Innovation (Journal of Technical Disclosure No. 2001-1745 published on Mar. 15, 2001 by Japan Institute of Invention and Innovation).

The cellulose acylate can be used singly, or a mixture of two or more kinds of the cellulose acrylates can be used as long as the substituent, the substitution degree, the polymerization degree, the molecular weight distribution, and the like are in the above ranges.

<<Transparent Supporting Body>>

The phase difference plate including the optically anisotropic layer has a transparent supporting body. As the transparent supporting body, a polymer film showing a positive Rth is preferably used. In addition, as the transparent supporting body, a polymer film having a low Re and a low Rth is also preferably used.

A material that forms the transparent supporting body that can be used in the invention is preferably a cellulose derivative in a case in which the transparent supporting body is adhered to the image display panel portion through the adhesive composition as described above. In a case in which the transparent supporting body is not adhered to the image display panel portion through the adhesive composition, a material that forms the transparent supporting body may not be a cellulose derivative, and examples thereof include polyester-polymers, such as polycarbonate-based polymers, polyethylene terephthalate, and polyethylene naphthalate, acryl-based polymers, such as polymethyl methacrylate, styrene-based polymers, such as polystyrene and acrylonitrile styrene copolymer (AS resin), and the like. In addition, the examples also include polyolefins, such as polyethylene and polypropylene, polyolefin-based polymers, such as ethylene propylene copolymers, vinyl chloride-based polymers, amide-based polymers, such as nylon and aromatic polyamide, imide-based polymers, sulfone-based polymers, polyether sulfone-based polymers, polyether ether ketone-based polymers, poly phenylene sulfide-based polymers, vinylidene chloride-base polymers, vinyl alcohol-based polymers, vinyl butyral-based polymers, acrylate-based polymers, polyoxy methylene-based polymers, epoxy-based polymers, or polymer mixtures. In addition, the high molecular film of the invention can be formed as a cured layer of an ultraviolet curable or thermal curable resin, such as an acryl-based resin, a urethane-based resin, an acryl urethane-based resin, an epoxy-based resin, and a silicone-based resin.

In addition, as a material for forming the transparent supporting body, a thermoplastic norbornene-based resin can be preferably used. The thermoplastic norbornene-based resin includes ZEONEX and ZEONOR, manufactured by Zeon Corporation, ARTON, manufactured by JSR Corporation, and the like.

In addition, as a material that forms the transparent supporting body, cellulose-based polymers that have been used as a transparent protective film for the polarization plate of the related art and are represented by the triacetyl cellulose can be used, and cellulose-based polymers (hereinafter referred to as cellulose acylates) can be preferably used.

The thickness of the transparent supporting body is preferably 10 μm to 120 μm, more preferably 20 μm to 100 μm, and still more preferably 30 μm to 90 μm. In addition, a preferable example of a polymer film that is used as the transparent supporting body is a phase difference film having an Re of 0 nm to 10 nm and an absolute value of the Rth of 20 nm or more.

<Optically Anisotropic Layer>

The optically anisotropic layer in the invention is a patterned optically anisotropic layer including first phase difference areas and second phase difference areas in which at least one of the inner surface retarded axis directions and the inner surface retardations are mutually different, in which the first and second phase difference areas are alternately disposed in the surface. An example is an optically anisotropic layer in which the first and second phase difference areas have a Re of approximately λ/4 respectively, and the inner surface retarded axes cross orthogonally with each other. A variety of methods can be used to form such an optically anisotropic layer, and, in the invention, the optically anisotropic layer is preferably formed by fixing an orientation state of a composition including a discotic liquid crystal having a polymerizable group.

The optically anisotropic layer may singly have an Re of approximately λ/4, and, in this case, the Re (550) is preferably 110 nm to 165 nm, more preferably 120 nm to 150 nm, and particularly preferably 125 nm to 145 nm. The Rth (550) of the optically anisotropic layer is preferable a negative value, preferably −80 nm to −50 nm, and more preferably −75 nm to −60 nm. When the Rth (550) of the optically anisotropic layer is a negative value, it is possible to offset the positive Rth of other members, and suppress brightness degradation in an inclined direction.

[Discotic Liquid Crystalline Compound Having a Polymerizable Group]

A discotic liquid crystal that can be used as a main raw material of the optically anisotropic layer of the invention is preferably a compound having a polymerizable group as described above.

The discotic liquid crystal is preferably a compound represented by the following general formula (1).

D(-L-H-Q)ₙ General formula (1):

In the formula, D indicates a disc-shaped core, L indicates a divalent coupling group, H indicates a divalent aromatic ring or a hetero ring, Q indicates a polymerizable group, and n indicates an integer of 3 to 12.

The disc-shaped core (D) is preferably a benzene ring, a naphthalene ring, a triphenylene ring, an anthraquinone ring, a truxene ring, a pyridine ring, a pyrimidine ring, and a triazine ring, and particularly preferably a benzene ring, a triphenylene ring, a pyridine ring, a pyrimidine ring, and a triazine ring.

L is preferably a divalent coupling group selected from a group consisting of *—O—CO—, *—CO—O—, *—CH═CH—, *—C≡C—, and combinations thereof, and particularly preferably a divalent coupling group including at least one or more of any of *—CH═CH— and *—C≡C—. Here, * represents a location at which L is bonded to D in the general formula (1).

H is preferably a benzene ring and a naphthalene ring, and particularly preferably a benzene ring as an aromatic ring, and is preferably a pyridine ring and a pyrimidine ring, and particularly preferably a pyridine ring as a hetero ring. H is particularly preferably an aromatic ring.

The polymerization reaction of the polymerizable group Q is preferably addition polymerization (including open-ring polymerization) or condensation polymerization. In other words, the polymerizable group is preferably a functional group that is available for an addition polymerization reaction or a condensation polymerization reaction. Among them, a (meth)acrylate group and an epoxy group are preferred.

The discotic liquid crystal represented by the general formula (1) is particularly preferably a discotic liquid crystal represented by the following general formula (II) or (III).

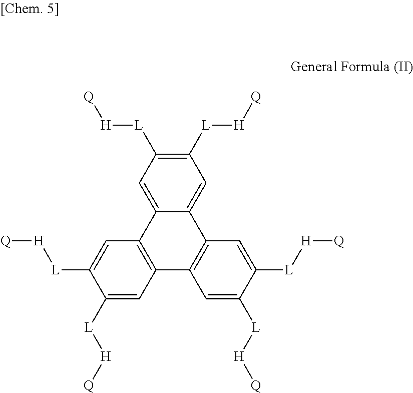

In the formula, L, H, and Q are the same as L, H, and Q in the general formula (1), and have the same preferred ranges.

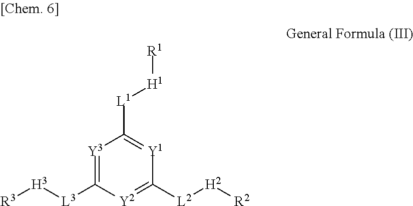

In the formula, Y¹, Y², and Y³ are the same as Y¹¹, Y¹², and Y¹³ in a general formula (IV) as described below, and have the same preferred ranges. In addition, L¹, L², L³, H¹, H², H³, R¹, R², and R³ are also the same as L, L², L³, H¹, H², H³, R¹, R², and R³ in the general formula (IV) as described below, and have the same preferred ranges.

As described below, since a discotic liquid crystal having a plurality of aromatic rings in the molecules as represented by the general formulae (I), (II), (II), and (IV) causes an intermolecular π-π interaction with an onium salt, such as a pyridinium compound, an imidazolium compound, or the like which is used as an orientation controlling agent, vertical orientation can be realized. Particularly, in a case in which, for example, L is a divalent coupling group including at least one or more of any of *—CH═CH— and *—C≡C— in the general formula (II), and in a case in which rings of a plurality of aromatic rings and hetero rings are bonded to each other through single bonds in the general formula (III), the free rotation of the bonds by the coupling group is strongly restricted so that the linearity of the molecules is held, and therefore the crystallinity is improved, a stronger intermolecular π-π interaction is caused, and stable vertical orientation can be realized.

The discotic liquid crystal is preferably a compound represented by the following general formula (IV).

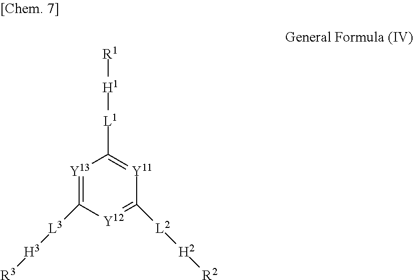

In the formula, Y¹¹, Y¹², and Y¹³ respectively represent methane or a nitrogen atom that may be substituted; L¹, L², and L³ respectively represent a single bond or divalent coupling group; H¹, H², and H³ respectively represent a group of the general formula (I-A) or (I-B); and R¹, R², and R³ respectively represent the following general formula (I-R).

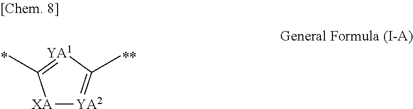

In the general formula (I-A), YA¹ and YA² respectively represent methane or a nitrogen atom; XA represents an oxygen atom, a sulfur atom, methylene, or imino; * represents locations that bond with L¹ to L³ sides in the general formula (IV); and ** represents locations that bond with R¹ to R³ sides in the general formula (IV).

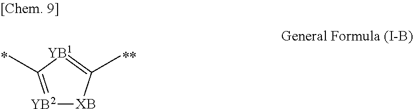

In the general formula (I-B), YB¹ and YB² respectively represent methane or a nitrogen atom; XB represents an oxygen atom, a sulfur atom, methylene, or imino; * represents locations that bond with L¹ to L³ sides in the general formula (IV); and ** represents locations that bond with R¹ to R³ sides in the general formula (IV). General formula (I-R)

*-(-L²¹-Q²)ₙ₁-L²²-L²³-Q¹

In the general formula (I-R), * represents locations that bond with H¹ to H³ sides in the general formula (IV); L²¹ represents a single bond or divalent coupling group; Q² represents a divalent group (cyclic group) having at least one kind of cyclic structure; n1 represents an integer of 0 to 4; L²² represents **—O—, **—O—CO—, **—CO—O—, **—O—CO—O—, **—S—, **—NH—, **—SO₂—, **—CH₂—, **—CH═CH— or **—C≡C—; L²³ represents —O—, —S—, —C(═O)—, —SO₂—, —NH—, —CH₂—, —CH═CH— and —C≡C— and a divalent coupling group selected from a group composed of combinations thereof; and Q¹ represents a polymerizable group or a hydrogen atom.

Reference can be made to Paragraphs [0013] to [0077] of JP2010-244038A for the preferred ranges of the respective symbols of the 3-substituted benzene-based discotic liquid crystalline compound represented by the formula (IV) and specific examples of the compound represented by the formula (IV). However, the discotic liquid crystalline compound that can be used in the invention is not limited to the 3-substituted benzene-based discotic liquid crystalline compound of the formula (IV).

Triphenylene compounds include the compounds as described in paragraphs [0062] to [0067] of JP2007-108732A, but the invention is not limited thereto.

Since the discotic liquid crystal represented by the general formula (IV) has a plurality of aromatic rings in the molecules, the discotic liquid crystal causes a strong intermolecular π-π interaction with a pyridinium compound or an imidazolium compound as described below, and the tilt angle in the vicinity of the surface of an oriented film of the discotic liquid crystal is increased. Particularly, since the discotic liquid crystal represented by the general formula (IV) has a plurality of aromatic rings coupled by single bonds, and thus has a highly linear molecular structure for which the degree of rotation freedom of the molecules is restricted, the discotic liquid crystal causes a stronger intermolecular π-π interaction with a pyridinium compound or an imidazolium compound, and the tilt angle in the vicinity of the surface of an oriented film of the discotic liquid crystal is increased.

In the invention, the discotic liquid crystal is preferably vertically oriented. Further, in the specification, the “vertical orientation” indicates that the disc surface of the discotic liquid crystal and the layer surface are vertical to each other. In the specification, the vertical orientation does not require the disc surface of the discotic liquid crystal and the layer surface to be strictly vertical to each other, and means that the inclination angle formed with the horizontal surface is 70 degrees or more. The inclination angle is preferably 85 degrees to 90 degrees, more preferably 87 degrees to 90 degrees, still more preferably 88 degrees to 90 degrees, and most preferably 89 degrees to 90 degrees.

Meanwhile, additives are preferably added to the composition to promote the vertical orientation of the liquid crystal, and examples of the additives include the compounds as described in [0055] to [0063] in JP2009-223001A.

Meanwhile, it is difficult to directly and accurately measure the tilt angle (an angle formed by physical symmetry axes with respect to the interface of the optically anisotropic layer in the liquid crystalline compound will be referred to as the tilt angle) θ1 on one surface of the optically anisotropic layer and the tilt angle θ2 on the other surface in the optically anisotropic layer in which the liquid crystalline compound is oriented. Therefore, in the specification, θ1 and θ2 are computed by the following method. The present method does not accurately express the actual orientation state of the invention, but is effective as a measure that expresses the relative relationship of a part of optical characteristics of the phase difference plate.

In the method, in order to ease the computation, the following two factors are assumed and used as the tilt angles in two interfaces of the optically anisotropic layer.

1. The optically anisotropic layer is assumed to be a multilayered body constituted by layers including the liquid crystalline compound. Furthermore, the minimum unit of the layer that composes the multilayered body (the tilt angle of the liquid crystalline compound are assumed to be the same in the layers) is optically assumed as an axis.

2. The tilt angles of the respective layers are assumed to monotonously change in a linear function manner along the thickness direction of the optically anisotropic layer.

The specific computation method is as follows:

(1) In the surface at which the tilt angles of the respective layers monotonously change in a linear function manner along the thickness direction of the optically anisotropic layer, the incident angle of measurement light with respect to the optically anisotropic layer changes, and retardation values are measured at three or more measurement angles. In order to simplify measurement and computation, it is preferable to set the normal direction with respect to the optically anisotropic layer to 0°, and measure retardation values at three measurement angles of −40°, 0°, +40°. The measurement can be carried out using a KOBRA-21ADH and a KOBRA-WR (manufactured by Oji Scientific Instruments), a transmission ellipsometer AEP-100 (manufactured by Shimadzu Corporation), M150 and M520 (manufactured by Jasco Corporation), and ABR10A (manufactured by Uniopt Corporation, Ltd.).

(2) In the above model, the refractive index of each layer for normal light is represented by no; the refractive index for abnormal light is represented by ne (ne is the same throughout all the layers, and no is also the same throughout all the layers), and the overall thickness of the multilayered body is represented by d. Furthermore, with an assumption that the tilt direction in each layer and the monoaxial optical axis direction thereof are the same, fitting is carried out using the tilt angle θ1 in one surface of the optically anisotropic layer and the tilt angle θ2 in the other surface as variables so that the computation of the angle dependence of the retardation value of the optically anisotropic layer coincides with a measured value, and θ1 and θ2 are computed.

Here, well-known values, such as values in publications and values in catalogs, can be used as no and ne. In a case in which the values are unknown, the values can be measured using an Abbe refractometer. The thickness of the optically anisotropic layer can be measured using an optical interference thickness gauge, a photograph of the cross section taken using a scanning electronic microscope, or the like.

[Onium Salt Compound (an Orientation Controlling Agent for the Oriented Film)]

In the invention, an onium salt is preferably added in order to realize the vertical orientation of the discotic liquid crystal having a polymerizable group as described above. The onium salt is eccentrically present at the oriented film interface, and has an action of increasing the tilt angle in the vicinity of the oriented film interface of liquid crystal molecules.

The onium salt is preferably a compound represented by the following general formula (1).

Z—(Y-L-)ₙCy⁺.X⁻ General formula (1)

In the formula, Cy is an onium group of a 5 or 6-membered ring, L, Y, Z, and X are the same as L²³, L²⁴, Y²², Y²³, Z²¹, and X in the general formulae (2a) and (2b) as described below, and also have the same preferred ranges, n represent an integer of 2 or more.

The onium group of a 5 or 6-membered ring (Cy) is preferably a pyrazolium ring, an imidazolium ring, a triazolium ring, a tetrazolium ring, a pyridinium ring, a pyrazinium ring, a pyrimidinium ring, or a triazinium ring, and particularly preferably an imidazolium ring or a pyridinium ring.

The onium group of a 5 or 6-membered ring (Cy) preferably has a group having an affinity to the oriented film material. Furthermore, the onium salt compound preferably has an affinity to the oriented film material which is high at a temperature T₁° C., but, conversely, degraded at a temperature T₂° C. In an actual temperature range (room temperature to approximately 150° C.), hydrogen bonds can be in a bonding state or a state in which the bonds are lost, and therefore use of an affinity due to hydrogen bonds is preferred. However, the affinity is not limited to the above example.

For example, in an aspect in which a polyvinyl alcohol is used as an oriented film material, the onium salt compound preferably has a hydrogen-bonding group in order to form a hydrogen bond with the hydroxyl group of the polyvinyl alcohol. Examples of theoretical analysis of the hydrogen bond include a report of H. Uneyama and K. Morokuma, Journal of American Chemical Society, Vol. 99. Pages 1316 to 1332, 1977. Examples of specific hydrogen bond forms include the forms as described in FIG. 17, page 98, Intermolecular Force and Surface Force, J. N. Israerachiviri, translated by Kondo Tamotsu and Oshima Hiroyuki, McGraw-Hill (1991). Examples of the specific hydrogen bonds include the hydrogen bond as described in G. R. Desiraju, Angewandte Chemistry International Edition English, Vol. 34, page 2311, 1995.

In addition to the effect of the affinity, the onium group of a 5 or 6-membered ring having the hydrogen-bonding group causes more oriented film interfaces to be eccentrically present on the surface due to the hydrogen bonds with the polyvinyl alcohol, and promotes a function of supplying an orthogonal orientation with respect to polyvinyl alcohol main chains. Preferable hydrogen-bonding groups include an amino group, a carbonamide group, a sulfonamide group, an acid amide group, an ureido group, a carbamoyl group, a carboxylic group, a sulfo group, a nitrogen-containing hetero ring group (for example, an imidazolyl group, a benzimidazolyl group, a pyrazolyl group, a pyridyl group, a 1,3,5-triazyl group, a pyrimidyl group, a pyridazyl group, a quinolyl group, a benzimidazolyl group, a benzthiazolyl group, a succinicimide group, a phthalimide group, a maleimide group, a uracil group, a thiouracil group, a barbituric acid group, a hydantoin group, a maleic hydrazide group, an isatin group, an uramyl, and the like). More preferable hydrogen-bonding group includes an amino group and a pyrizyl group.

For example, it is also preferable that an atom having a hydrogen-bonding group be contained in the onium ring of a 5 or 6-membered ring as the nitrogen atom in an imidazolium ring.

n is preferably an integer of 2 to 5, more preferably an integer of 3 or 4, and particularly preferably 3. A plurality of L and Y may be mutually the same or different. In a case in which n is 3 or more, since the onium salt represented by the general formula (1) has three or more 5 or 6-membered rings, a strong intermolecular π-π interaction works with the discotic liquid crystal, and therefore it is possible to realize a vertical orientation of the discotic liquid crystal, particularly, on a polyvinyl alcohol oriented film, an orthogonal vertical orientation with respect to the polyvinyl alcohol main chain.

The onium salt represented by the general formula (1) is particularly preferably a pyridinium compound represented by the following general formula (2a) or an imidazolium compound represented by the following general formula (2b).

The compound represented by the general formulae (2a) and (2b) is added in order mainly to control the orientation in the oriented film interface of the discotic liquid crystal represented by the general formulae (1) to (IV), and has an action of increasing the tilt angle in the vicinity of the oriented film interface of the molecules in the discotic liquid crystal.

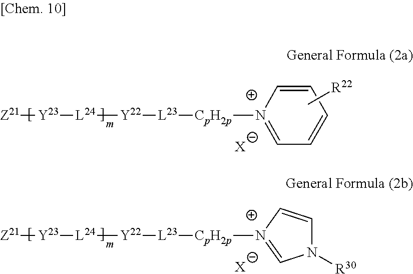

In the formula, L²³ and L²⁴ represent a divalent coupling group respectively.

L²³ is preferably a single bond, —O—, —O—CO—, —CO—O—, —C≡C—, —CH═CH—, —CH═N—, —N═CH—, —N═N—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—, and AL is an alkylene group having 1 to 10 carbon atoms. L²³ is preferably a single bond, —O—, —O-AL-O—, —O-AL-O—CO—, —O-AL-CO—O—, —CO—O-AL-O—, —CO—O-AL-O—CO—, —CO—O-AL-CO—O—, —O—CO-AL-O—, —O—CO-AL-O—CO—, or —O—CO-AL-CO—O—, more preferably a single bond or —O—, and most preferably —O—.

L²⁴ is preferably a single bond, —O—, —O—CO—, —CO—O—, —C≡C—, —CH═CH—, —CH═N—, —N═CH—, —N═N—, and more preferably —O—CO— or —CO—O—. When m is 2 or more, a plurality of L²⁴ is more preferably —O—CO— and —CO—O— alternately.

R²² is a hydrogen atom, an unsubstituted amino group, or a substituted amino group having 1 to 20 carbon atoms.

In a case in which R²² is a dialkyl-substituted amino group, a nitrogen-containing hetero ring may be formed by mutually binding two alkyl groups. The nitrogen-containing hetero ring formed at this time is preferably a 5-membered ring or a 6-membered ring. R²³ is more preferably a hydrogen atom, an unsubstituted amino group, or a dialkyl substituted amino group having 2 to 12 carbon atoms, and still more preferably a hydrogen atom, an unsubstituted amino group, or a dialkyl substituted amino group having 2 to 8 carbon atoms. In a case in which R²³ is an unsubstituted amino group and a substituted amino group, four positions of the pyridinium ring are preferably substituted.

X is an anion.

X is preferably a monovalent anion. Examples of the anion include a halide ion (a fluorine ion, a chlorine ion, a bromine ion, and an iodine ion) and a sulfonic acid ion (for example, a methane sulfonate ion, a p-toluenesulfonate ion, and a benzene sulfonate ion).

Y²² and Y²³ are respectively a divalent coupling group having a 5 or 6-membered ring as the partial structure.

The 5 or 6-membered ring may have a substituent. Preferably, at least one of Y²² and Y²³ is a divalent coupling group having a 5 or 6-membered ring that has a substituent as the partial structure. Y²² and Y²³ are preferably a divalent coupling group having a 6-membered ring that may have a substituent as the partial structure respectively. The 6-membered ring includes an aliphatic ring, an aromatic ring (benzene ring), and a hetero ring. Examples of the 6-membered aliphatic ring include a cyclohexane ring, a cyclohexene ring, and a cyclohexadiene ring. Examples of the 6-membered hetero ring include a pyran ring, a dioxane ring, a dithiane ring, a thiine ring, a pyridine ring, a piperidine ring, an oxazine ring, a morpholine ring, a thiazine ring, a pyridazine ring, a pyrimidine ring, a pyrazine ring, a piperazine ring and a triazine ring. The 6-membered ring may have other 6-membered or 5-membered rings condensed therein.

Examples of the substituent include a halogen atom, cyano, an alkyl group having 1 to 12 carbon atoms, and an alkoxy group having 1 to 12 carbon atoms. The alkyl group and the alkoxy group may be substituted with an acyl group having 2 to 12 carbon atoms or an acyloxy group having 2 to 12 carbon atoms. The substituent is preferably an alkyl group having 1 to 12 carbon atoms (more preferably 1 to 6 carbon atoms, and still more preferably 1 to 3 carbon atoms). The number of the substituents may be 2 or more. For example, in a case in which Y²² and Y²³ are a phenylene group, the alkyl group and the alkoxy group may be substituted with 1 to 4 alkyl groups having 1 to 12 carbon atoms (more preferably 1 to 6 carbon atoms, and still more preferably 1 to 3 carbon atoms).

Meanwhile, m is 1 or 2, and preferably 2. When m is 2, a plurality of Y²³ and L²⁴ may be mutually the same or different.

Z²¹ is a monovalent group selected from a group consisting of a halogen-substituted phenyl, a nitro-substituted phenyl, a cyano-substituted phenyl, a phenyl substituted with an alkyl group having 1 to 10 carbon atoms, a phenyl substituted with an alkoxy group having 2 to 10 carbon atoms, an alkyl group having 1 to 12 carbon atoms, an alkynyl group having 2 to carbon atoms, an alkoxy group having 1 to 12 carbon atoms, an alkoxycarbonyl group having 2 to 13 carbon atoms, an aryloxycarbonyl group having 7 to 26 carbon atoms, and an arylcarbonyl group having 7 to 26 carbon atoms.

In a case in which m is 2, Z²¹ is preferably cyano, an alkyl group having 1 to 10 carbon atoms, or an alkoxy group having 1 to 10 carbon atoms, and still more preferably an alkoxy group having 4 to 10 carbon atoms.

In a case in which m is 1, Z²¹ is preferably an alkyl group having 7 to 12 carbon atoms, an alkoxy group having 7 to 12 carbon atoms, an acyl-substituted alkyl group having 7 to 12 carbon atoms, an acyl-substituted alkoxy group having 7 to 12 carbon atoms, an acyloxy-substituted alkyl group having 7 to 12 carbon atoms, and an acyloxy-substituted alkoxy group having 7 to 12 carbon atoms.

An acyl group is represented by —CO—R, an acyloxy group is represented by —O—CO—R, and R is an aliphatic group (an alkyl group, a substituted alkyl group, an alkenyl group, a substituted alkenyl group, an alkynyl group, or a substituted alkynyl group) or an aromatic group (an aryl group, or a substituted aryl group). R is preferably an aliphatic group, and more preferably an alkyl group or an alkenyl group.

p is an integer of 1 to 10. p is particularly preferably 1 or 2. CₚH₂ₚ refers to a chain-shaped alkylene group that may have a branched structure. CₚH₂ₚ is preferably a straight-chain alkylene group (—(CH₂)ₚ—).

In the formula (2b), R³⁰ is an alkyl group having 1 to 12 (more preferably 1 to 6, and still more preferably 1 to 3) hydrogen atoms or carbon atoms.

Among the compounds represented by the formula (2a) or (2b), the compounds represented by the formula (2a′) or (2b′) are preferred.

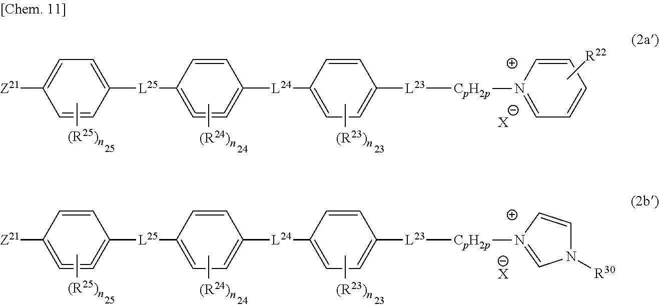

In the formulae (2a′) and (2b′), the same reference numerals as in the formula (2) have the same meaning and the same preferred ranges. L²⁵ and L²⁴ have the same meaning and the same preferred ranges. L²⁴ and L²⁵ are preferably —O—CO— or —CO—O—, and it is preferable that L²⁴ be —O—CO— and L²⁵ be —CO—O—.

R²³, R²⁴, and R²⁵ are respectively an alkyl group having 1 to 12 (more preferably 1 to 6, and still more preferably 1 to 3) carbon atoms. n₂₃ represents 0 to 4, n₂₄ represents 1 to 4, and n₂₅ represents 0 to 4. It is preferable that n₂₃ and n₂₅ be 0, and n₂₄ be 1 to 4 (more preferably 1 to 3).

R³⁰ is preferably an alkyl group having 1 to 12 (more preferably 1 to 6, and still more preferably 1 to 3) carbon atoms.

Specific examples of the compound represented by the general formula (2) include the compounds as described in [0058] to [0061] in JP2006-113500A.

Hereinafter, specific examples of the compound represented by the general formula (2′) are shown. However, in the following formulae, anions (X⁻) are not shown.

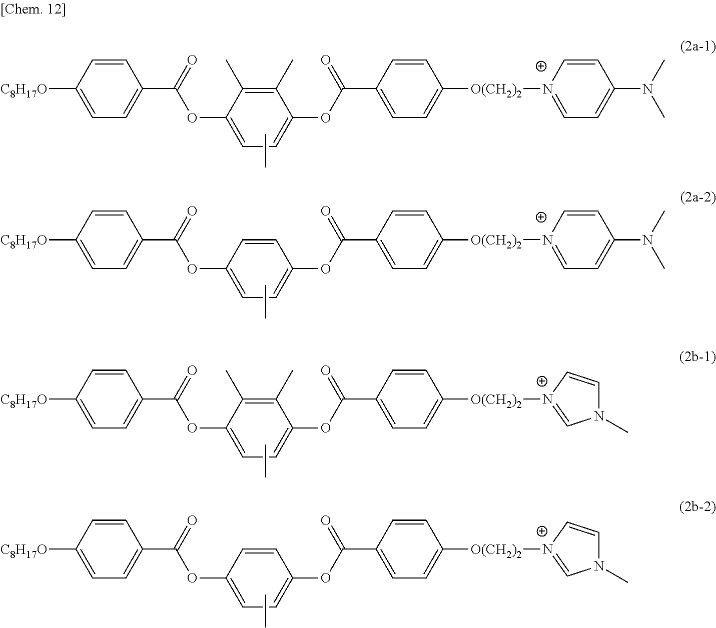

The compounds of the formulae (2a) and (2b) can be manufactured by an ordinary method. For example, the pyridinium derivative of the formula (2a) is obtained by ordinarily alkylating (Menschutkin reaction) a pyridine ring.

The added amount of the onium salt does not exceed 5% by mass with respect to the liquid crystalline compound, and is preferably approximately 0.1% by mass to 2% by mass.

The onium salt represented by the general formulae (2a) and (2b) is eccentrically present on the surface of a hydrophilic polyvinyl alcohol oriented film since the pyridinium group or the imidalinium group is hydrophilic. Particularly, when the pyridinium group is further substituted with an amino group, which is a substituent of the acceptor of a hydrogen atom (in the general formulae (2a) and (2a′), R²² is an unsubstituted amino group or a substituted amino group having 1 to 20 carbon atoms), an intermolecular hydrogen bond is generated between the onium salt and a polyvinyl alcohol, the onium salt is eccentrically present on the oriented film surface more densely, and the pyridinium derivative is oriented in an orthogonal direction to the main chain of the polyvinyl alcohol due to the effect of the hydrogen bond, and therefore orthogonal orientation of the liquid crystals with respect to a rubbing direction is promoted. Since the pyridinium derivative has a plurality of aromatic rings in the molecules, a strong intermolecular π-π interaction is caused between the pyridinium derivative and the liquid crystal, particularly, the discotic liquid crystal, and orthogonal orientation is induced in the vicinity of the oriented film surface of the discotic liquid crystal. Particularly, when a hydrophobic aromatic ring is bonded to a hydrophilic pyridinium group as represented by the general formula (2a′), the hydrophobic effect also results in an effect of inducing a vertical orientation.

Furthermore, when the onium salt represented by the general formulae (2a) and (2b) is jointly used, a parallel orientation in which the retarded axes of the liquid crystal are oriented in parallel with the rubbing direction can be promoted by heating the onium salt to higher than a certain temperature. This is because the hydrogen bonds with the polyvinyl alcohol are broken due to thermal energy by the heating, the onium salt is uniformly dispersed in the oriented film, the density on the surface of the oriented film is lowered, and the liquid crystal is oriented by the restraining force of a rubbing oriented film.

[Fluoro Aliphatic Group-Containing Copolymer (Air Interface Orientation Controlling Agent)]

The fluoro aliphatic group-containing copolymer is added in order to control the orientation in the air interface of the liquid crystal, mainly the discotic liquid crystal represented by the general formula (I), and has an action of increasing the tilt angle in the vicinity of the air interface of the molecules of the liquid crystal. Furthermore, the coating properties are also improved by preventing variation, cissing, and the like.

The fluoro aliphatic group-containing copolymer that can be used in the invention includes the compounds as described in JP2004-333852A, JP2004-333861A, JP2005-134884A, JP2005-179636A, JP2005-181977, and the like, and is particularly preferably a fluoro aliphatic group-containing copolymer which is a polymer including in the side chains a fluoro aliphatic group and one or more kinds of hydrophilic groups selected from a group consisting of a carboxylic group (—COOH), a sulfo group (—SO₃H), phosphonoxy {—OP(═O)(OH)₂}, and salts thereof all of which are described in JP2005-179636A and JP2005-181977.

The added amount does not exceed 2% by mass with respect to the liquid crystalline compound, and is preferably approximately 0.1% by mass to 1% by mass.

The fluoro aliphatic group-containing copolymer can increase the eccentricity to the air interface due to the hydrophobic effect of the fluoro aliphatic group, supply a low surface energy field to the air interface side, and increase the tilt angle of the liquid crystal, particularly, the discotic liquid crystal. Furthermore, when the fluoro aliphatic group-containing copolymer has a copolymer component including one or more kinds of hydrophilic groups selected from a group consisting of a carboxylic group (—COOH), a sulfo group (—SO₃H), phosphonoxy {—OP(═O)(OH)₂}, and salts thereof at the side chain, it is possible to realize vertical orientation of the liquid crystal compound due to charge repulsion between anions thereof and the π electrons in the liquid crystal.

[Solvent]

The composition that is used to form the optically anisotropic layer is preferably prepared as a coating fluid. A solvent that is used to prepare the coating fluid is preferably an organic solvent. Examples of the organic solvent include amides (for example, N,N-dimethylformamide), sulfoxides (for example, dimethylsulfoxide), heterocyclic compounds (for example, pyridine), hydrocarbons (for example, benzene and hexane), alkyl halides (for example, chloroform and dichloromethane), esters (for example, methyl acetate and butyl acetate), ketones (for example, acetone and methyl ethyl ketone), and ethers (for example, tetrahydrofuran and 1,2-dimethoxyethane). Alkyl halides and ketones are preferred. Two or more kinds of the organic solvents may be jointly used.

[Polymerization Initiator]

A composition (for example, the coating fluid) containing the liquid crystalline compound having the polarizable group is made to have an orientation state in which a desired liquid crystalline phase is shown, and then the orientation state is fixed through ultraviolet irradiation. The orientation state is preferably fixed by a polymerization reaction of a reactive group that is introduced to the liquid crystalline compound. The orientation state is preferably fixed by a photopolymerization reaction caused by ultraviolet irradiation. The photopolymerization may be any of radical polymerization and cation polymerization. Examples of the radical photopolymerization initiator include α-carbonyl compounds (U.S. Pat. No. 2,367,661B and U.S. Pat. No. 2,367,670B), acyloin ethers (U.S. Pat. No. 2,448,828B), α-hydrocarbon substituted aromatic acyloin compounds (U.S. Pat. No. 2,722,512B), polynuclear quinone compounds (U.S. Pat. No. 3,046,127B and U.S. Pat. No. 2,951,758B), a combination of triarylimidazole dimer and p-aminophenyl ketone (U.S. Pat. No. 3,549,367B), acridine and phenazine compounds (JP1985-105667A (JP-S60-105667A) and U.S. Pat. No. 4,239,850B) and oxadiazole compounds (U.S. Pat. No. 4,212,970B). Examples of the cation photopolymerization initiator that can be proposed include organic sulfonium salt-based, iodonium salt-based, and phosphonium salt-based photopolymerization initiators, organic sulfonium salt-based photopolymerization initiators are preferred, and triphenyl sulfonium salt is particularly preferred. As the counterion of the compounds, hexafluoroantimonite, hexafluorophosphate, and the like are preferably used.

The used amount of the photopolymerization initiator is preferably 0.01% by mass to 20% by mass, and more preferably 0.5% by mass to 5% by mass of the solid content of the coating fluid.

[Sensitizer]

In addition, a sensitizer as well as the polymerization initiator may also be used to increase the sensitivity. Examples of the sensitizer include n-butylamine, triethylamine, tri-n-butylphosphine, thioxanthone, and the like. Plural kinds of the photopolymerization initiators may be combined, and the used amount of the photopolymerization initiator is preferably 0.01% by mass to 20% by mass, and more preferably 0.5% by mass to 5% by mass of the solid content of the coating fluid. Ultraviolet rays are preferably used for light irradiation for polymerization of the liquid crystalline compound.

[Other Additives]

Separately from the polymerizable liquid crystal compound, the composition may also contain a non-liquid crystalline polymerizable monomer. The polymerizable monomer is preferably a compound having a vinyl group, a vinlyoxy group, an acryloyl group, or a methacryloyl group. Meanwhile, when a multifunctional monomer having 2 or more polymerizable reactive functional groups, for example, ethylene oxide-modified trimethylolpropane acrylate is used, the durability is improved, which is preferable. Since the non-liquid crystalline polymerizable monomer is a non-liquid crystalline component, the added amount thereof does not exceed 40% by mass with respect to the liquid crystalline compound, and is preferably approximately 0% by mass to 20% by mass.

The thickness of the optically anisotropic layer manufactured in the above manner is not particularly limited, but is preferably 0.1 μm to 10 μm, and more preferably 0.5 μm to 5 μm.

<Oriented Film>

The oriented film that can realize a patterned optically anisotropic layer may be formed between the optically anisotropic layer and the transparent supporting body. A rubbing oriented film is preferably used as the oriented film.

The “rubbing oriented film” that can be used in the invention refers to films that are subjected to a rubbing treatment so as to provide an orientation-regulating function of liquid crystal molecules. The rubbing oriented film has an orientation axis that regulates the orientation of the liquid crystal molecules, and the liquid crystal molecules are oriented in accordance with the orientation axis. The material of the oriented film, an acid generating agent, a liquid crystal, and an orientation controlling agent are selected so that the liquid crystal molecules are oriented in parallel with the retarded axis of the liquid crystal with respect to the rubbing direction at the ultraviolet-irradiated portions of the oriented film, and the retarded axis of the liquid crystal molecules are orthogonally oriented with respect to the rubbing direction at the non-irradiated portions.

Generally, the rubbing oriented film has a polymer as a main component. Polymer materials for the oriented film are described in many publications, and can be obtained from many commercially available products. The polymer material that is used in the invention is preferably polyvinyl alcohol, polyimide, or derivatives thereof, and particularly preferably modified or unmodified polyvinyl alcohol. The polyvinyl alcohol has a variety of saponification degrees. In the invention, a polyvinyl alcohol having a saponification degree of approximately 85 to 99 is preferably used. A commercially available product may be used, and, for example, “PVA 103,” “PVA 203,” (manufactured by Kuraray Co., Ltd.) and the like are PVAs having the above saponification degree. With regard to the rubbing oriented film, the modified polyvinyl alcohols as described in line 24 on page 43 through line 8 on page 49 in WO01/88574A1 and paragraphs [0071] to [0095] of JP3907735B can be referenced. The thickness of the rubbing oriented film is preferably 0.01 μm to 10 μm, and more preferably 0.01 μm to 1 μm.

Generally, the rubbing treatment can be carried out by rubbing the surface of a film having a polymer as a main component with paper or a fabric in a constant direction several times. An ordinary method of the rubbing treatment is described in, for example, “Liquid Crystal Handbook,” (Maruzen Company, Limited, Oct. 30, 2000).

As a method for changing the rubbing density, it is possible to use the method as described in “Liquid Crystal Handbook,” (Maruzen Company, Limited, Oct. 30, 2000). The rubbing density (L) is quantified by the following formula (A).

L=Nl(1+2πrn/60v) Formula (A)

In the formula (A), N represents a rubbing cycle, l represents the contact length of the rubbing roller, r represents the radius of the roller, n represents the rotation speed (rpm) of the roller, and v is the stage moving speed (per second).

An increase in the rubbing density requires an increase in the rubbing cycle, an increase in the contact length of the rubbing roller, an increase in the radius of the roller, an increase in the rotation speed of the roller, and a decrease of the stage moving speed, and a decrease in the rubbing density requires the opposite operations.

The rubbing density and the pretilt angle have a relationship in which an increase in the rubbing density results in a decrease in the pretilt angle, and a decrease in the rubbing density results in an increase in the pretilt angle.

In order to adhere to a long polarization film having an absorption axis in the longitudinal direction, it is preferable to form an oriented film on a supporting body composed of a long polymer film, and carry out the rubbing treatment continuously in a 45° direction with respect to the longitudinal direction, thereby forming a rubbing oriented film.

If possible (for example, in a case in which light irradiation for decomposing a photo acid generating agent and light irradiation for developing a light orientation function can be separately carried out), a light oriented film may be used.

In addition, the oriented film may contain at least one kind of photo acid generating agent. The photo acid generating agent refers to a compound that is decomposed by light irradiation of ultraviolet rays or the like so as to generate an acidic compound. When the photo acid generating agent is decomposed by light irradiation so as to generate an acidic compound, a change in the orientation controlling function of the oriented film is caused. The change in the orientation controlling function as mentioned herein may be specified as a change in the orientation controlling function of the oriented film only, a change in the orientation controlling function that is achieved by the oriented film and additives included in the composition for the optically anisotropic layer disposed thereon, and the like, or a change specified as a combination of the above two.

There are cases in which the discotic liquid crystal is made to have an orthogonally vertical orientation state when the onium salt is added. When an acid generated by the decomposition and the onium salt exchange the anions, a parallel vertical orientation state may be formed by degrading the eccentricity of the onium salt on the oriented film surface, and degrading the orthogonally vertical orientation effect. In addition, for example, in a case in which the oriented film is a polyvinyl alcohol-based oriented film, the eccentricity of the onium salt at the oriented film interface may be consequently changed by decomposing the ester portion using the generated acid.

The optically anisotropic layer can be formed by a variety of methods in which the oriented film is used, and the method is not particularly limited.

A first aspect is a method in which a plurality of actions that affect the orientation control of the discotic liquid crystal is used, and then some actions are lost due to external stimuli (a thermal treatment and the like), thereby making predetermined orientation control actions dominant. For example, the discotic liquid crystal is made to have a predetermined orientation state using a combined action of an orientation control function of an oriented film and an orientation control function of an orientation controlling agent added to the liquid crystalline composition, the orientation state is fixed so as to form a phase difference area, then, one of the actions (for example, the action of the orientation controlling agent) is lost due to external stimuli (a thermal treatment and the like), the other orientation control action (the action of the oriented film) is made to be dominant so as to realize another orientation state, and the orientation state is fixed so as to form the other phase difference area. For example, since the pyridinium group or the imidazolium group in the pyridinium compound represented by the general formula (2a) or the imidazolium compound represented by the general formula (2b) is hydrophilic, the group is eccentrically present on the surface of the hydrophilic polyvinyl alcohol oriented film. Particularly, when the pyridinium group is further substituted with an amino group, which is a substituent of the acceptor of a hydrogen atom (in the general formulae (2a) and (2a′), R²² is an unsubstituted amino group or a substituted amino group having 1 to 20 carbon atoms), an intermolecular hydrogen bond is generated between the onium salt and a polyvinyl alcohol, the onium salt is eccentrically present on the oriented film surface more densely, and the pyridinium derivative is oriented in an orthogonal direction to the main chain of the polyvinyl alcohol due to the effect of the hydrogen bond, and therefore the liquid crystals are promoted to be orthogonally oriented with respect to a rubbing direction. Since the pyridinium derivative has a plurality of aromatic rings in the molecules, a strong intermolecular π-π interaction is caused between the pyridinium derivative and the liquid crystal, particularly, the discotic liquid crystal, and an orthogonal orientation is induced in the vicinity of the oriented film surface of the discotic liquid crystal. Particularly, when a hydrophobic aromatic ring is bonded to a hydrophilic pyridinium group as represented by the general formula (2a′), the hydrophobic effect also results in an effect of inducing a vertical orientation. However, when the optically anisotropic layer is heated to higher than a certain temperature, the hydrogen bonds are broken, the density of the pyridinium compound and the like on the surface of the oriented film is lowered, and the actions are lost. As a result, the liquid crystal is oriented by the restraining force of the rubbing oriented film, and the liquid crystal is made to have a parallel orientation state. The above method is described in detail in JP2010-141345A, and the contents are cited from the specification thereof.

A second aspect is an aspect in which the pattern oriented film is used. In this aspect, pattern oriented films having mutually different orientation controlling functions are formed, a liquid crystal composition is disposed on the pattern oriented films, and the liquid crystal is oriented. The orientation of the liquid crystal is regulated by the respective orientation controlling functions of the pattern orientation films; and mutually different orientation states are achieved. When the respective orientation states are fixed, the patterns of the first and second phase difference areas are formed according to the patterns of the oriented films. The pattern oriented films can be formed by a printing method, mask-rubbing with respect to a rubbing oriented film, mask exposure with respect to a photo oriented film, or the like. In addition, it is also possible to form a pattern oriented film by uniformly forming an oriented film, and separately printing additives that affect the orientation controlling function (for example, the onium salt and the like) in a predetermined pattern. A method in which a printing method is used is preferred since a large facility is not required, and manufacturing is easy. The above method is described in detail in JP2010-173077A, and the contents are cited from the specification thereof.

In addition, the first and second aspects may be jointly used. An example is that a photo acid generating agent is added to the oriented film. In this example, the photo acid generating agent is added to the oriented film, the photo acid generating agent is decomposed by pattern exposure so as to form an area in which an acidic compound is generated and an area in which an acidic compound is not generated. In portions in which light is not irradiated, the photo acid generation agent is seldom decomposed, the interaction among the oriented film material, the liquid crystal, and an orientation controlling agent that is added according to desire dominates the orientation state, and the liquid crystal is oriented in a direction in which the retarded axis crosses orthogonally with the rubbing direction. When light is irradiated to the oriented film, and an acidic compound is generated, the interaction conversely loses the dominancy, the rubbing direction of the rubbing oriented film dominates the orientation state, and the liquid crystal is oriented in parallel in which the retarded axis is in parallel with the rubbing direction. A water-soluble compound is preferably used as the photo acid generating agent that is used for the oriented film. Examples of available photo acid generating agents include the compounds as described in Prog. Polym. Sci., Vol 23, page 1485 (1998). A pyridinium salt, an iodonium salt, and a sulfonium salt are particularly preferably used as the photo acid generating agent. The above method is described in detail in JP2010-289360, and the contents are cited from the specification thereof.

Furthermore, as a third aspect, there is a method in which discotic liquid crystals having polymerizable groups for which the polymerization properties are mutually different (for example, an oxetanyl group and a polymerizable ethylenic unsaturated group) are used. In this aspect, the discotic liquid crystals are made to have a predetermined orientation state, and then light irradiation and the like are carried out under conditions in which a polymerization reaction of only one polymerizable group proceeds, thereby forming a pre-optically anisotropic layer. Next, mask exposure is carried out under conditions in which the other polymerizable group can be polymerized (for example, in the presence of a polymerization initiator that initiates the polymerization of the other polymerizable group). The orientation state of the exposed portions is completely fixed, and one phase difference area having a predetermined Re is formed. In unexposed areas, a reaction of one reactive group proceeds, but the other reactive group remains unreacted. Therefore, when the liquid crystal is heated to a temperature exceeding an isotropic phase temperature at which a reaction of the other reactive group can proceed, the unexposed area is fixed in an isotropic phase state, that is, Re becomes 0 nm.

<Polarization Layer>

An ordinary polarization film can be used as the polarization layer that can be used in the invention. For example, it is possible to use a polarization film composed of a polyvinyl alcohol film and the like which are dyed using iodine or a dichromatic colorant.

<Adhesion Layer>

An adhesion layer may also be disposed between the optically anisotropic layer and the polarization film. The adhesion layer used for laminating the optically anisotropic layer and the polarization film refers to, for example, a substance for which the ratio of G′ to G″ (tan δ=G″/G′) which is measured using a dynamic viscoelastic measurement apparatus is 0.001 to 1.5, in other words, adhesives, easily-creeping substances, and the like. The adhesive is not particularly limited, and, for example, a polyvinyl alcohol-based adhesive can be used. In addition, an adhesive composition may be disposed.

<Anti-Reflection Layer>

It is preferable to provide a functional film, such as an anti-reflection layer, on the surface of the polarization plate which is disposed opposite to the liquid crystal cell. Particularly, in the invention, an anti-reflection layer in which at least a light scattering layer and a low refractive index layer are laminated in this order on a substrate film or an anti-reflection layer in which an intermediate reflective index layer, a high refractive index layer, and a low refractive index layer are laminated in this order on a substrate film is preferably used. This is because such an anti-reflection layer can effectively prevent occurrence of flicker due to external light reflection particularly in a case in which 3D images are displayed. The anti-reflection layer may further have a hard coating layer, a forward scattering layer, a primer layer, an antistat layer, a basecoat layer, a protective layer, or the like. Details of the respective layers that compose the anti-reflection layer are described in [0182] to [0220] in JP2007-254699A, and the preferred characteristics, materials, and the like can be similarly applied to the anti-reflection layer that can be used in the invention.

The substrate film may also serve as a transparent supporting body of the optically anisotropic layer. Examples of polymer films that can be used as the substrate film include the same examples of the transparent supporting body of the optically anisotropic layer, and the preferable ranges are also the same.

<Liquid Crystal Cell>

The liquid crystal cell used in the 3D image display apparatus that is used in the 3D image display system of the invention is preferably a VA mode, an OCB mode, an IPS mode, or a TN mode, but is not limited thereto.

In the liquid crystal cell in the TN mode, when no voltage is applied, the rod-shaped liquid crystalline molecules are oriented substantially horizontally, and, furthermore, twisted at 60° to 120°. The liquid crystal cell in the TN mode is most widely used as a color TFT liquid crystal display apparatus, and described in many publications.

In the liquid crystal cell in the VA mode, rod-shaped liquid crystalline molecules are oriented substantially vertically when no voltage is applied. The liquid crystal in the VA mode includes (1) a liquid crystal cell in the VA mode in a narrow definition in which rod-shaped liquid crystalline molecules are oriented substantially vertically when no voltage is applied, and substantially horizontally when voltage is applied (described in JP1990-176625A (JP-H2-176625A)), (2) a liquid crystal cell (in the MVA mode) for which the VA mode is made into multi domains for view angle enlargement (described in SID97, Digest of Tech. Papers (Proceedings) 28 (1997) 845), (3) a liquid crystal cell in a mode in which rod-shaped liquid crystalline molecules are oriented substantially vertically when no voltage is applied, and twisted so as to be oriented into multi domains when voltage is applied (n-ASM mode) (described in the Proceedings of Japanese Liquid Crystal Society 58 to 59 (1998)), and (4) a liquid crystal cell in a survival mode (presented in the LCD International 98). In addition, the liquid crystal may have any of a patterned vertical alignment (PVA) type, an optical alignment type, and polymer-sustained alignment (PSA). The details of the above modes are described in JP2006-215326A and JP2008-538819A.

In the liquid cell in the IPS mode, the rod-shaped liquid crystal molecules are disposed substantially in parallel to the substrate, and, when a parallel electric field is applied to the substrate surface, the liquid crystal molecules respond in a planar manner. The IPS mode displays black in an electric field-free state, and the transmission axes of a pair of top and bottom polarization plates cross orthogonally with each other. A method in which leaked light in an inclined direction while displaying black is reduced using an optical retardation sheet so as to improve the view angle is disclosed in JP1998-54982A (JP-H10-54982A), JP1999-202323A (JP-H11-202323A), JP1997-292522A (JP-H9-292522A), JP1999-133408A (JP-H11-133408A), JP1999-305217A (JP-H11-305217A), JP1998-307291A (JP-H10-307291A), and the like.

<Polarization Plate for the 3D Image Display System>

In the stereoscopic image display system of the invention, images are recognized through a polarization plate in order particularly to enable an observer to recognize stereoscopic images that are termed 3D images. An aspect of the polarization plate is polarized glasses. In an aspect in which right-eye and left-eye circularly polarized images are formed using a phase difference plate, circularly polarized glasses are used, and, in an aspect in which linearly polarized images are formed, linear glasses are used. The polarization plate is preferably configured so that right-eye image light rays ejected from one of the first and second phase difference areas of the optically anisotropic layer are allowed to pass through the right-eye glass, but shielded at the left-eye glass, and left-eye image light rays ejected from the other of the first and second phase difference areas are allowed to pass through the left-eye glass, but shielded at the right-eye glass.

The polarized glasses include a phase difference function layer and a linear polarizer so as to form polarized glasses. Meanwhile, other members having the same function as the linear polarizer may be used.

The specific configuration of the 3D image display system of the invention including the polarization glasses will be described. Firstly, the phase difference plate is provided with the first phase difference areas and the second phase difference areas having different polarization conversion functions on a plurality of first lines and a plurality of second lines that are alternately repeated in the image display panel (for example, odd number lines and even number lines in the horizontal direction when the lines are in the horizontal direction, and odd number lines and even number lines in the vertical direction when the lines are in the vertical direction). In a case in which circularly polarized light is used for display, the phase difference at the first phase difference areas and the second phase difference areas is preferably λ/4, and it is more preferable that the retarded axes of the first phase difference areas and the second phase difference areas cross orthogonally with each other.

In a case in which circularly polarized light is used, the phase difference values of the first phase difference areas and the second phase difference areas are all set to λ/4, right-eye images are displayed at odd number lines in the image display panel, when the retarded axes of the odd number line phase difference areas are in a 45 degree direction, λ/4 plates are preferably disposed at both the right-eye glass and the left-eye glass of the polarization glasses, and the retarded axis of the λ/4 plate of the right-eye glass of the polarization glasses simply needs to be fixed at specifically approximately 45 degrees. In addition, in the above situation, similarly, left-eye images are displayed at even number lines in the image display panel, and the retarded axis of the left-eye glass of the polarization glasses simply needs to be fixed at specifically approximately 135 degrees when the retarded axes of the even number line phase difference areas are in a 135 degree direction.

Furthermore, the angle of the retarded axis fixed by the right-eye glass in an example of the above case is preferably close to accurately 45 degrees in the horizontal direction from the standpoint that image light is once ejected as circularly polarized light at the patterning phase difference film, and the polarization state is returned to the original using, the polarization glasses. In addition, the angle of the retarded axis fixed by the left-eye glass is preferably close to accurately horizontal 135 degrees (or −45 degrees).

In addition, for example, in a case in which the image display panel is a liquid crystal display panel, it is preferable that the direction of the absorption axis of the front-side polarization plate of the liquid crystal display panel be ordinarily in the horizontal direction, and the absorption axis of the linear polarizer of the polarized glasses be in a direction orthogonal to the direction of the absorption axis of the front-side polarization plate, and the absorption axis of the linear polarizer of the polarization glasses is more preferably in a vertical direction.

In addition, the direction of the absorption axis of the front-side polarization plate of the liquid crystal display panel and the respective retarded axes of the odd number line phase difference areas and the even number line phase difference areas in the patterning phase difference film preferably form 45 degrees in terms of the polarization conversion efficiency.

Meanwhile, a preferred disposition of such polarization glasses, the patterning phase difference film, and the liquid crystal display apparatus is disclosed in, for example, JP2004-170693A.

Examples of the polarization glasses include the polarization glasses as described in JP2004-170693A and accessories of ZM-M220 W, manufactured by Zalman Tech Co., which is a commercially available product.

### EXAMPLES

Hereinafter, the invention will be described more specifically based on examples. Materials, amounts used, proportions, treatment contents, treatment sequences, and the like as shown in the following examples can be appropriately modified within the scope of the purport of the invention. Therefore, the scope of the invention is not interpreted to be limited to specific examples as shown below.

<<Preparing of a Urethane (Meth)Acrylate-Based Macromonomer>>

Table 1 shows synthesized urethane (meth)acrylate-based macromonomers. Hereinafter, a method of manufacturing a urethane (meth)acrylate-based macromonomer A will be described. A urethane (meth)acrylate-based macromonomer B was synthesized in the same manner.

(Method of Preparing a Urethane Acrylate A)

A droplet of dibutyltin laurate was added to 2 moles of isophorone diisocyanate, the mixture was stirred at 70 degrees, 1 mole of polypropylene glycol was added dropwise, the mixture was stirred, reacted for 3 hours, then, 2 moles of hydroxylethyl acrylate was added dropwise, and the mixture was stirred for 3 hours, thereby producing a urethane acrylate A.

<<Measurement of the Mass Average Molecular Weights and Number Average Molecular Weights of the Raw Materials>>

0.1% by mass of a part of polypropylene glycol 1000 (manufactured by Wako Pure Chemical Industries, Ltd.) was dissolved in tetrahydrofuran (THF), the mass average molecular weight and the number average molecular weight were measured using gel permeation chromatography (GPC), and the mass average molecular weight was 1586, and the number average molecular weight was 1447. In the invention, the mass average molecular weight and the number average molecular weight were values obtained using polystyrene as a standard substance.

<<Measurement of the Glass Transition Temperature of the Urethane (Meth)Acylate-Based Macromonomer>>

The glass transition temperatures of the urethane (meth)acrylate-based macromonomers A and B were measured through differential scanning calorimetry (DSC).

TABLE 1

| Urethane | Hydroxyl group-containing | Polyisocyanate | | | Number of |
|---|---|---|---|---|---|
| (meth)acrylate-based | (meth)acrylate compound | compound | | Glass transition | functional |
| macromonomer | (monomer) | (diisocyanate) | Polyol compound (diol) | temperature [° C.] | groups |
| A | 2-Hydroxy ethyl acrylate | Isophorone | Polypropylene glycol 1000 | −32 | 2 |
| | | diisocyanate | Mass average molecular weight | | |
| | | | 1586 | | |
| | | | Number average molecular | | |
| | | | weight 1447 | | |
| B | 2-Hydroxy ethyl acrylate | Isophorone | Polypropylene glycol 3000 | −54 | 2 |
| | | diisocyanate | Mass average molecular weight | | |
| | | | 4889 | | |
| | | | Number average molecular | | |
| | | | weight 2495 | | |

TABLE 2

| Ultraviolet | | Urethane(meth) | | | Volume |
|---|---|---|---|---|---|
| curable | | acrylate-based | | Viscosity | shrinkage |
| composition | Monomer | macromonomer | Photopolymerization initiator | (mPa · s) | rate |
| A | 2-Ethylhexyl acrylate | Urethane acrylate A | 2-Methyl-4′-(methylthio)-2-morpholinopropiophenone | 43 | 5.0% |
| | 8.4 g | 6.0 g | 0.6 g | | |
| B | 2-Ethylhexyl acrylate | Urethane acrylate B | 2-Methyl-4′-(methylthio)-2-morpholinopropiophenone | 53 | 4.5% |
| | 8.4 g | 6.0 g | 0.6 g | | |

### Example 1

<<Manufacturing of a 3D Image Display Apparatus>>

<Manufacturing of a transparent supporting body A>

The following composition was injected into a mixing tank, heated, and stirred so as to dissolve the respective components, thereby preparing a cellulose acylate solution A.

Composition of the cellulose acylate solution A

| | |
|---|---|
| Cellulose acylate having a substitution degree of 2.86 | 100 parts by mass |
| Triphenyl phosphate (plasticizer) | 7.8 parts by mass |
| Biphenyl diphenyl phosphate (plasticizer) | 3.9 parts by mass |
| Methylene chloride (first solvent) | 300 parts by mass |
| Methanol (second solvent) | 54 parts by mass |
| 1-Butanol | 11 parts by mass |

The following composition was injected into another mixing tank, heated, and stirred so as to dissolve the respective components, thereby preparing a additive solution B.

Composition of the additive solution B

| | |
|---|---|
| The following compound B1 (Re lowering agent) | 40 parts by mass |
| The following compound B2 (wavelength | 4 parts by mass |
| dispersion controlling agent) | |
| Methylene chloride (first solvent) | 80 parts by mass |
| Methanol (second solvent) | 20 parts by mass |

[Chem. 13]
Compound Bl 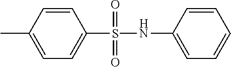
Compound B2

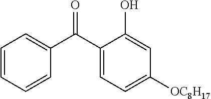

<<Manufacturing of a Cellulose Acetate Transparent Supporting Body>>

40 parts by mass of the additive solution B was added to 477 parts by mass of the cellulose acylate solution A, and the mixture was sufficiently stirred, thereby preparing a dope. The dope was cast on a drum cooled to 0° C. from a casting hole. The dope was peeled off at an external field having a solvent content of 70% by mass, fixed at both ends in the width direction of the film using pin stenters (the pin stenter as described in FIG. 3 in JP1992-1009 (JP-H4-1009)), and dried in a state in which the solvent content was 3% by mass to 5% by mass while intervals were maintained so that the stretching rate in the horizontal direction (a direction perpendicular to the machine direction) became 3%. After that, the dope was further dried by being transported between rolls in a thermal treatment apparatus so as to manufacture a 60 μm-thick cellulose acetate protective film (transparent supporting body A). The transparent supporting body A was an Re (550) of 0 nm and an Rth (550) of 12.3 nm.

<<Alkali Saponification Treatment>>

The cellulose acetate transparent supporting body A was made to pass through dielectric heating rolls at a temperature of 60° C. so as to increase the temperature of the film surface to 40° C., then, an alkali solution having the following composition was coated on one surface of the film using a bar coater at a coating amount of 14 ml/m², the film was heated to 110° C., and transported for 10 seconds under a steam-type far-infrared heater manufactured by Noritake Co., Ltd. Subsequently, 3 ml/m² of pure water was coated using the bar coater in a similar manner. Next, water washing using a fountain coater and drainage using an air knife was repeated three times, and then the film was transported and dried in a drying zone at 70° C. for 10 seconds, thereby manufacturing a cellulose acetate transparent supporting body A.

Composition of the alkali solution (parts by mass)

| | |
|---|---|
| Potassium hydroxide | 4.7 parts by mass |
| Water | 15.8 parts by mass |
| Isopropanol | 63.7 parts by mass |
| Surfactant SF-1: C₁₄H₂₉O (CH₂CH₂O)₂₀H | 1.0 part by mass |
| Propylene glycol | 14.8 parts by mass |

<Manufacturing of a Rubbing Oriented Film-Attached Transparent Supporting Body>

A coating fluid for a rubbing oriented film having the following composition was continuously coated on the saponified surface of the manufactured supporting body using a No. 8 wire bar. The coating fluid was dried using hot air at 60° C. for 60 seconds and, furthermore, hot air at 100° C. for 120 seconds so as to form an oriented film. Next, a stripe mask having a horizontal stripe width of 285 μm in the transmission portions and a horizontal stripe width of 285 μm in the shielding portions was disposed on the rubbing oriented film, ultraviolet rays were irradiated to a UV-C area in the air at room temperature for 4 seconds using an air cooling metal halide lamp having an illuminance of 2.5 mW/cm² (manufactured by Eye Graphics Co., Ltd.), and a photo acid generating agent was decomposed so as to generate an acidic compound, thereby forming an oriented film for the first phase difference areas. After that, a rubbing treatment was carried out for one cycle in a single direction at 500 rpm while the angle with respect to the stripe mask was held at 45° so as to manufacture a rubbing oriented film-attached glass supporting body. Meanwhile, the thickness of the oriented film was 0.5 μm.

Composition of a composition for forming the oriented film

| | |
|---|---|
| Polymer material for the oriented film | 3.9 parts by mass |
| (PVA 103, polyvinyl alcohol manufactured | |
| by Kuraray Co., Ltd.) | |
| Photo acid generating agent (S-2) | 0.1 parts by mass |
| Methanol | 36 parts by mass |
| Water | 60 parts by mass |

[Chem. 14]
Photo Acid Generating Agent S-2

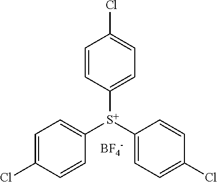

<Manufacturing of a Patterned Optically Anisotropic Layer A>

The following coating fluid for an optically anisotropic layer was coated using a bar coater at a coating amount of 4 ml/m². Next, the coating fluid was heated and matured for 2 minutes at a film surface temperature of 110° C., then, cooled to 80° C., ultraviolet rays were irradiated for 20 seconds in the air using a 20 mW/cm² air cooling metal halide lamp (manufactured by Eye Graphics Co., Ltd.), and the orientation state was fixed, thereby forming a patterned optically anisotropic layer A. The retarded axis direction was in parallel with the rubbing direction, and the discotic liquid crystal was vertically oriented in the mask exposed portion (the first phase difference areas), and the discotic liquid crystal was vertically oriented alternately in the unexposed portion (the second phase difference areas). Meanwhile, the film thickness of the optically anisotropic layer was 0.9 μm.

Composition of the coating fluid for the optically anisotropic layer

| | |
|---|---|
| Discotic liquid crystal E-1 | 100 parts by mass |
| Oriented film surfactant (II-1) | 3.0 parts by mass |
| Air surfactant (P-1) | 0.4 parts by mass |
| Polymerization initiator | 3.0 parts by mass |
| (IRGACURE 907, manufactured by Ciba Specialty Chemicals Inc.) | |
| Sensitizer (KAYACURE-DETX, manufactured by Nippon Kayaku Co., Ltd.) | 1.0 part by mass |
| Methyl ethyl ketone | 400 parts by mass |

[Chem. 15]
Discotic Liquid Crystal E-1 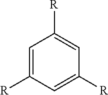 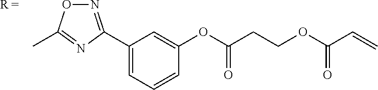
Oriented Film Interface Orientating Agent (II-1) 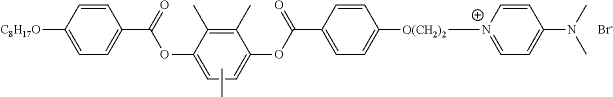
Air Interface Orientating Agent (P-1)

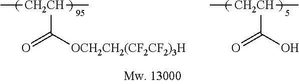

<Manufacturing of the Surface Layer A>

<<Manufacturing of an Anti-Reflection Layer>>

[Preparation of a Coating Fluid for a Hard Coating Layer]

The following composition was injected into a mixing tank and stirred so as to produce a coating fluid for a hard coating layer.

100 parts by mass of cyclohexane, 750 parts by mass of partial caprolactone-modified multifunctional acrylate (DPCA-20, manufactured by Nippon Kayaku Co., Ltd.), 200 parts by mass of silica sol (MIBK-ST, manufactured by Nissan Chemical Industries, Ltd.), and 50 parts by mass of a photopolymerization initiator (IRGACURE 186, manufactured by Ciba Specialty Chemicals Inc.) were added to 900 parts by mass of methyl ethyl ketone, the mixture was stirred and filtered using a polypropylene filter having a pore diameter of 0.4 μm, thereby preparing the coating fluid for a hard coating layer.

[Preparation of a Coating Fluid for an Intermediate Refractive Index Layer]

1.5 parts by mass of a mixture of dipentaerythritol pentaacrylate and dipentaerythritol hexacrylate (DPHA), 0.05 parts by mass of a photopolymerization initiator (IRGACURE 907, manufactured by Ciba Specialty Chemicals Inc.), 66.6 parts by mass of methyl ethyl ketone, 7.7 parts by mass of methyl isobutyl ketone, and 19.1 parts by mass of cyclohexanone were added to 5.1 parts by mass of a ZrO₂ fine particle-containing hard coating agent (DESOLITE Z7404 [refractive index 1.72, solid content concentration: 60% by mass, content of zirconium oxide fine particles: 70 mass % (with respect to the solid content), average particle diameter of zirconium oxide fine particles: approximately 20 nm, solvent composition: methyl isobutyl ketone/methyl ethyl ketone=9/1, manufactured by JSR Corporation]), and the mixture was stirred. After sufficiently stirred, the mixture was filtered using a polypropylene filter having a pore diameter of 0.4 μm so as to prepare a coating fluid A for a hard coating layer.

[Preparation of a Coating Fluid for an Intermediate Refractive Index Layer B]

4.5 parts by mass of a mixture of dipentaerythritol pentaacrylate and dipentaerythritol hexacrylate (DPHA), 0.14 parts by mass of a photopolymerization initiator (IRGACURE 907, manufactured by Ciba Specialty Chemicals Inc.), 66.5 parts by mass of methyl ethyl ketone, 9.5 parts by mass of methyl isobutyl ketone, and 19.0 parts by mass of cyclohexanone were added and stirred. After sufficiently stirred, the mixture was filtered using a polypropylene filter having a pore diameter of 0.4 μm so as to prepare a coating fluid B for a hard coating layer.

Appropriate amounts of the coating fluid A for an intermediate refractive index layer and the coating fluid B for an intermediate refractive index layer were mixed so as to have a refractive index of 1.36 and a film thickness of 90 μm, thereby preparing an intermediate refractive index coating fluid.

[Preparation of a Coating Fluid for a High Refractive Index Layer]

0.75 parts by mass of a mixture of dipentaerythritol pentaacrylate and dipentaerythritol hexacrylate (DPHA), 62.0 parts by mass of methyl ethyl ketone, 3.4 parts by mass of methyl isobutyl ketone, and 1.1 parts by mass of cyclohexanone were added to 14.4 parts by mass of a ZrO₂ fine particle-containing hard coating agent (DESOLITE Z7404 [refractive index 1.72, solid content concentration: 60% by mass, content of zirconium oxide fine particles: 70 mass % (with respect to the solid content), average particle diameter of zirconium oxide fine particles: approximately 20 nm, solvent composition: methyl isobutyl ketone/methyl ethyl ketone=9/1, manufactured by JSR Corporation]), and the mixture was stirred. After sufficiently stirred, the mixture was filtered using a polypropylene filter having a pore diameter of 0.4 μm so as to prepare a coating fluid C for a high refractive index layer.

[Preparation of a Coating Fluid for a Low Refractive Index Layer]

(Synthesis of a Perfluoroolefin Copolymer (1))

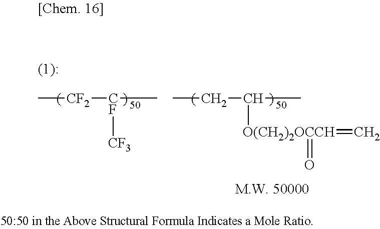

40 ml of ethyl acetate, 14.7 g of hydroxyl ethyl vinyl ether, and 0.55 g of dilauroyl peroxide were placed in a stainless steel stirrer-attached autoclave having a capacity of 100 ml, the air in the system was exhausted, and substituted with nitrogen gas. Furthermore, 25 g of hexafluoropropylene (HFP) was introduced to the autoclave, and the mixture was heated to 65° C. When the temperature in the autoclave reached 65° C., the pressure was 0.53 MPa (5.4 kg/cm²). A reaction continued for 8 hours while the temperature was held, heating was stopped when the pressure reached 0.31 MPa (3.2 kg/cm²), and the mixture was cooled. Unreacted monomer was extracted when the internal temperature was decreased to room temperature, the autoclave was opened, and the reaction solution was taken out. The obtained reaction solution was injected into a significant excess of hexane, and the solvent was removed by decantation, thereby extracting settled polymer. Furthermore, the polymer was dissolved in a small amount of ethyl acetate, and made to settle again from the hexane twice, thereby completely removing the residual monomer. After drying, 28 g of the polymer was obtained. Next, 20 g of the polymer was dissolved in 100 ml of N,N-dimethyl acetamide, 11.4 g of acrylic acid chloride was added dropwise during ice cooling, and the mixture was stirred at room temperature for 10 hours. Ethyl acetate was added to the reaction solution, the mixture was washed using water, an organic layer was extracted, then condensed, and the obtained polymer was made to settle again, thereby producing 19 g of perfluoroolefin copolymer (1). The refractive index of the obtained polymer was 1.422, and the mass average molecular weight was 50000.

[Preparation of a Hollow Silica Particle Dispersion Liquid A]

30 parts by mass of acryloyloxy propyl trimethoxysilane and 1.51 parts by mass of diisopropoxy aluminum ethyl acetate were added to 500 parts by mass of a hollow silica particle fine particle sol (isopropyl alcohol silica sol, CS60-IPA manufactured by Catalysts & Chemicals Ind. Co., Ltd., average particle diameter: 60 nm, shell thickness: 10 nm, silica concentration: 20% by mass, refractive index of silica particles: 1.31), mixed, and then 9 parts by mass of ion exchange water was added. The mixture was reacted at 60° C. for 8 hours, then, cooled to room temperature, and 1.8 parts by mass of acetyl acetone was added, thereby producing a dispersion liquid. After that, while cyclohexanone was added so that the content of the silica content remained almost constant, the solvent was substituted by vacuum distillation at a pressure of 30 Torr, and, finally, 18.2% by mass of a dispersion liquid A was obtained by concentration adjustment. As a result of the gas chromatography, the IPA residual amount of the obtained dispersion liquid was 0.5% by mass or less.

[Preparation of a Coating Fluid for the Low Refractive Index Layer]

The respective components were mixed as follows, and dissolved in methyl ethyl ketone, thereby manufacturing a coating fluid Ln6 for the low refractive index layer having a solid content concentration of 5% by mass. The % by mass of the respective components below indicates the ratio of the solid contents of the respective components with respect to the total solid content of the coating fluid.

| | |
|---|---|
| P-1: perfluoroolefin copolymer (1) | 15% by mass |
| DPHA: a mixture of dipentaerythritol pentaacrylate and | 7% by mass |
| dipentaerythritol hexacrylate | |
| (manufactured by Nippon Kayaku Co., Ltd.) | |
| MF1: the following fluorine-containing unsaturated | 5% by mass |
| compound as described in the examples | |
| of WO2003/022906 (mass average molecular weight: 1600) | |
| M-1: KAYARAD DPHA, manufactured by | 20% by mass |
| Nippon Kayaku Co., Ltd. | |
| Dispersion liquid A: a hollow silica particle dispersion | 50% by mass |
| liquid A (a hollow silica particle sol | |
| whose surface was modified by acryloyloxy propyl | |
| trimethoxysilane, solid content concentration: 18.2%) | |
| Irg 127: a photopolymerization initiator, IRGACURE 127 | 3% by mass |
| (manufactured by Ciba Specialty Chemicals Inc.) | |

[Chem. 17]
Fluorine-Containing Unsaturated Compound

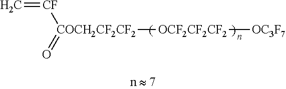

A TD80UL (manufactured by Fuji Film Holdings Corporation, Re/Rth=2/40 at 550 nm) was used as the surface film supporting body A, and a coating fluid for a hard coating layer having the composition was coated using a gravure coater on the surface film supporting body A. The TD80UL included an ultraviolet absorbent. After the coating fluid was dried at 100° C., while nitrogen purging was carried out so that an atmosphere having an oxygen concentration of 1.0% by volume or less was formed, ultraviolet rays having an illuminance of 400 mW/cm² and an irradiance level of 150 mJ/cm² were irradiated using a 160 W/cm air cooling metal halide lamp (manufactured by Eye Graphics Co., Ltd.) so as to cure the coating layer, thereby forming a 12 μm-thick hard coating layer A.

Furthermore, the coating fluid for the intermediate refractive index layer, the coating fluid for the high refractive index layer, and the coating fluid for the low refractive index layer were coated using a gravure coater. The drying conditions of the intermediate refractive index layer were set to 90° C. and 30 seconds, and the ultraviolet curing conditions were set to an illuminance of 300 mW/cm² and an irradiance level of 240 mJ/cm² using a 180 W/cm air cooling metal halide lamp (manufactured by Eye Graphics Co., Ltd.) while nitrogen purging was carried out so as to form an atmosphere having an oxygen concentration of 1.0 volume % or less.

The drying conditions of the high refractive index layer were set to 90° C. and 30 seconds, the illuminance and the irradiance level were set to 300 mW/cm² and 240 mJ/cm² respectively using a 240 W/cm air cooling metal halide lamp (manufactured by Eye Graphics Co., Ltd.) while nitrogen purging was carried out so as to form an atmosphere having an oxygen concentration of 1.0 volume % or less.

The drying conditions of the low refractive index layer were set to 90° C. and 30 seconds, the illuminance and the irradiance level were set to 600 mW/cm² and 600 mJ/cm² respectively using a 240 W/cm air cooling metal halide lamp (manufactured by Eye Graphics Co., Ltd.) while nitrogen purging was carried out so as to form an atmosphere having an oxygen concentration of 0.1 volume % or less. A surface film A was manufactured in the above manner.

<Manufacturing of a Phase Difference Plate A>

The TD80UL surface of the manufactured surface film A and the optically anisotropic layer surface of the patterned optically anisotropic layer A were adhered to each other using the adhesive as described in Example 1 of JP2008-151933A so as to manufacture a phase difference plate A having the configuration of FIG. 1A.

<Manufacturing of a Polarization Plate A>

A TD80UL (manufactured by Fuji Film Holdings Corporation, Re/Rth=2/40 at 550 nm) was used as a protective film A for the polarization plate A, and the surface was subjected to an alkali saponification treatment. The film was immersed in a 1.5N aqueous solution of sodium hydroxide at 55° C. for 2 minutes, washed in a water-washing tank at room temperature, and neutralized using 0.1N sulfuric acid at 30° C. Again, the film was washed in the water-washing tank, and, furthermore, dried using 100° C. hot air.

Subsequently, an 80 μm-thick roll-shaped polyvinyl alcohol film was continuously stretched to five times the original length in an aqueous solution of iodine, and dried, thereby producing a 20 μm-thick polarization film. The alkali-saponified TD80UL film and a similarly alkali-saponified VA phase difference film (manufactured by Fuji Film Holdings Corporation, Re/Rth=50/125 at 550 nm) were adhered between the polarization films so that the saponified surfaces faced the polarization films using a 3% aqueous solution of polyvinyl alcohol (PVA-117H, manufactured by Kuraray Co., Ltd.) as an adhesive, thereby manufacturing a polarization plate A in which the TD80UL film and the VA phase difference film served as the protective film for the polarization films. The angle formed by the retarded axis of the phase difference film and the transmission axis of the polarization film at this time was made to be 45 degrees.

<Manufacturing of a Display Panel>

The polarization plate of a LCD 22 WMGX, manufactured by NEC Corporation, on the observation side was peeled off, and the VA phase difference film and the LC cell in the manufactured polarization plate A were adhered to each other through an adhesive, thereby manufacturing a display panel having the configuration of FIG. 1A. Meanwhile, the orientation of the transmission axis of the polarization film is the same as in FIG. 3.

<Manufacturing of a 3D Image Display Apparatus>

The ultraviolet curable composition A was coated using an applicator between the transparent supporting body of the phase difference plate A and the protective film A for the display panel so as to become 10 μm thick, aligned in accordance with pixels, and ultraviolet rays were irradiated at an illuminance of 2 mW/cm² for 10 minutes using an UV irradiator (manufactured by Toshiba Lighting & Technology Corporation, black light) so as to adhere the phase difference and the pixels (46-inch size, designed value per array pitch of 530.06 μm), thereby manufacturing a 3D image display apparatus 1.

### Example 2

A 3D image display apparatus 2 was manufactured in the same manner as in Example 1 except that the ultraviolet curable composition A was changed to the ultraviolet curable composition B in Example 1.

### Comparative Example 1

A 3D image display apparatus 3 was manufactured in the same manner as in Example 1 except that the ultraviolet curable composition A was changed to the pressure-sensitive adhesive in Example 1 as described in JP1996-209095A (JP-H8-209095A) in Example 1.

### Comparative Example 2

A 3D image display apparatus 4 was manufactured in the same manner as in Example 1 except that the ultraviolet curable composition A was changed to SD-640 (manufactured by DIC Corporation, the glass transition temperature after being cured was 86° C.) in Example 1.

### Comparative Example 3

A 3D image display apparatus 5 was manufactured in the same manner as in Example 1 except that the transparent supporting body was changed from triacetyl cellulose to a cycloolefin copolymer in Example 1.

After wet hot tests (stored at 60° C. and 90% for 120 hours) were carried out on the image display apparatuses 1 to 5, the values of crosstalk were measured following a publication (Liquid Crystals, 2101, 14, 219.), and the values before and after the wet hot tests were compared. The results are shown in the following table.

TABLE 3

| | Amount of crosstalk | Amount of crosstalk | Amount |
|---|---|---|---|
| | before wet hot test | after wet hot test | changed (Δ) |
| Example 1 | 5.0% | 5.5% | +0.5 |
| Example 2 | 4.8% | 5.7% | +0.9 |
| Comparative | 10.8% | 13.0% | +2.2 |
| Example 1 | | | |
| Comparative | 11.3% | 14.0% | +2.7 |
| Example 2 | | | |
| Comparative | 5.4% | 7.4% | +2.0 |
| Example 3 | | | |

It is found from the table that less crosstalk occurred after the wet hot test in the image display apparatuses to which a cellulose derivative was adhered using the adhesive composition for a 3D image display apparatus of the invention than in Comparative Examples 1 to 3.

What is claimed is:

1. A 3D image display apparatus comprising:
an image display panel portion that is driven based on image signals; and
a phase difference plate that is disposed on an observation side of the image display panel portion and has at least a patterned optically anisotropic layer,
wherein the image display panel portion and the phase difference plate are adhered to each other through an adhesive composition having a glass transition temperature of room temperature or lower, and
at least one of surfaces adhered through the adhesive composition is a film including a cellulose derivative.

2. The 3D image display apparatus according to claim 1, wherein the adhesive composition is cured by ultraviolet rays.

3. The 3D image display apparatus according to claim 1, wherein the adhesive composition contains a polyol compound.

4. The 3D image display apparatus according to claim 2, wherein the adhesive composition contains a polyol compound.

5. The 3D image display apparatus according to claim 3, wherein the polyol compound is a urethane acrylate.

6. The 3D image display apparatus according to claim 4, wherein the polyol compound is a urethane acrylate.

7. The 3D image display apparatus according to claim 1, wherein the viscosity of the adhesive composition before being cured is 0.1 cP to 1000 cP.

8. The 3D image display apparatus according to claim 1, wherein the mass average molecular weight of the adhesive composition is 100 to 1×10⁷.

9. The 3D image display apparatus according to claim 1, wherein the phase difference plate has a film including a cellulose derivative that supports the patterned optically anisotropic layer, and a surface of the film is adhered to the image display panel portion.

10. The 3D image display apparatus according to claim 1, wherein the phase difference plate has a polarizer and a film including a cellulose derivative laminated on a surface of the polarizer, and a surface of the film is adhered to the image display panel portion.

11. The 3D image display apparatus according to claim 1, wherein a film including a cellulose derivative is provided on the adhered surface of the image display panel portion.

12. The 3D image display apparatus according to claim 1, wherein the cellulose derivative is triacetyl cellulose.

13. The 3D image display apparatus according to claim 1, wherein the image display panel portion has a liquid crystal cell.

14. A 3D image display system comprising:
the 3D image display apparatus according to claim 1, and
glasses for making each of right-eye and left-eye polarized images displayed on the 3D image display apparatus incident on each of the right eye and left eye of an observer.

15. A method of manufacturing the 3D image display apparatuses according to claim 1 comprising at least:
aligning the phase difference plate having at least a patterned optically anisotropic layer and the image display panel portion in a state in which the adhesive composition having a glass transition temperature of room temperature or less is interposed; and
adhering the phase difference plate and the image display panel portion by curing the adhesive composition after the aligning.

16. A phase difference plate for a 3D image display apparatus, comprising at least:
a patterned optically anisotropic layer,
wherein an adhesive layer including an adhesive composition having a glass transition temperature of room temperature or lower is provided on one surface.

17. The phase difference plate for a 3D image display apparatus according to claim 16, further comprising:
a film including a cellulose derivative,
wherein the adhesive layer is provided on a surface of the film.

18. An adhesive composition for a 3D image display apparatus, containing a polyol compound, for which the glass transition temperature is room temperature or lower.
